(19) United States
(12) Patent Application Publication
(10) Pub. No.: US 2007/0222971 A1
(43) Pub. Date: Sep. 27, 2007

(54) Apparatus to measure absolute velocity and acceleration

(76) Inventor: Etienne Brauns, Mol (BE)

Correspondence Address: ETIENNE BRAUNS, LEMMENSBLOK 2, MOL, B-2400, omitted

(21) Appl. No.: 11/684,618

(22) Filed: Mar. 11, 2007

Related U.S. Application Data
(60) Provisional application No. 60/784,460, filed on Mar. 22, 2006.

(51) Int. Cl. G01P 3/36

(52) U.S. Cl. 356/28; 356/614

(57) ABSTRACT

A three-dimensional (x′-axis, y′-axis and z′-axis based) combined light-based apparatus for measuring the absolute velocity and acceleration of a material object in space. The apparatus has for each axis, while each axis is perpendicular to each other axis, an identical set-up of: a photon (light) emitting source; zero to multiple mirrors; a photon sensitive sensor, possibly CCD-based. The emitted photons are directed to the sensor with or without one or multiple reflections from zero to multiple mirrors. The photons, emitted by the source, arrive at the sensor at a location determined by the momentarily absolute velocity of the apparatus in Newton's absolute space; the absolute velocity of the apparatus thus being calculable from this location on the sensor by adequate mathematical formulas. During acceleration, the time derivative of the location's shift is a function of the value of the acceleration of the apparatus; the acceleration of the apparatus is thus calculable from the time derivative of this location's shift by adequate mathematical formulas. If the velocity in only one direction (one dimension) should be measured, a single velocity measuring set-up is adequate.

### BACKGROUND OF THE INVENTION

Information about velocity, acceleration and also position of material objects which are moving in space is of prime importance in mechanically oriented technologies or applications, in particular within space travel applications. Up to now, only the measurement of the relative velocity of a moving object was considered to be possible, as a result of relativity considerations, as introduced already by Galileo. Relativity theories exclude the possibility to measure a moving object's absolute velocity. Absolute velocity was defined by Isaac Newton since in Newton's view, absolute velocity must exist since he considered space to be at absolute rest. When thus considering a reference frame at absolute rest in Newton's absolute space, the velocity of a moving material object as measured in such frame is therefore the absolute velocity of the object, according to Newton. However, no experimental evidence could be presented up to now with respect to the absolute velocity of a moving material object. In the present invention, the existence of an object's absolute velocity is theoretically and experimentally demonstrated. As a result, an absolute velocity measuring device is introduced and the present invention therefore is directed to the measurement of absolute velocity (including acceleration and position) of moving material objects in space. The straightforward and non refutable theoretical and experimental basics, upon which the invention is founded, are explained in the Detailed Description of the Invention.

The present invention enables to measure the absolute velocity and in principle the acceleration of a material object in Newton's absolute space when having a specific measurement apparatus, attached to the object. As an example, when incorporating the measurement device rigidly in a satellite or a space vessel, it is possible to measure the absolute velocity of the satellite or space vessel. Evidently, also the movement of the earth, other planets or moons, can be measured accordingly when mounting a measurement system, as described in this invention, on that planet or moon. Numerous applications can be considered in this way.

Moreover the apparatus could be deployed in the calculation of an object's position. As a first example, the very large velocity of the earth in its orbit around the sun, provokes a significant difference between the perceptible and the real position of an object on earth, as a result of the finite velocity of light as an information carrier. The present invention allows to be integrated in the calculation of the object's real position on earth from its perceptible position. This could be important in a high precision determination of position and precise positioning of objects on earth or space, when located at larger distances. As a second example, the present invention could be in principle a basis for setting up an arrangement of functional beacons in space in order to determine another space vehicle's precise position in space.

The possibility of an integral measurement of absolute velocity and acceleration while being also able to assist in determining an object's real position is new and therefore the present invention is of considerable importance with respect to further scientific developments and human's knowledge of our universe and technological implications there from. The present invention can contribute to further technological developments regarding the important evaluation of absolute velocity, acceleration and position in (space) applications of technological, thus industrial, value.

### BRIEF SUMMARY OF THE INVENTION

The invention is based on the observation that a photon's (light) trajectory in Newton's absolute space (vacuum) is linear (see note) and linked to absolute space. Moreover, the speed of light in vacuum is constant and its value is 299792458 m/sec and therefore it is well known that the velocity of the photon is independent from the velocity of the light source which produces the photon. The velocity of photons in vacuum (speed of light in vacuum) are not influenced by the source's velocity and the mechanistic approach of adding the source's velocity to the photon's velocity (speed of light) is not applicable to photons, in whatever direction. This has been proved in physics through numerous experiments, including the original Michelson-Morley experiment.

Note: it could be argued that there would be an effect on the linear trajectory in the immediate vicinity of extremely large masses but this effect is of an extremely marginal importance and is to be completely neglected within the geometry and size scale (order of magnitude: 1 meter) of the measurement device of the present invention.

As a result of this observation, photons (light) can be used in a specific measurement device set-up, which is the subject of the present invention, to measure the absolute velocity of a moving material object. The measurement device is rigidly attached to the material object in order to perform the envisaged object's absolute velocity measurements. Basically, the measuring device includes at least a photon (light) source and a photon sensitive sensor, being mounted rigidly in the apparatus. A laser, generating laser pulses, is preferred as photon source. As an example, the sensor is a perfectly flat electronic CCD device which enables to detect laser pulses at a high spatial pixel resolution. As an example of one possible embodiment, the laser is mounted on the device's rigid frame, according to a perfect geometrical alignment in a way that the emitted laser pulse is geometrically directed perfectly perpendicular towards the CCD sensor's plane. In this example the laser pulse travels perpendicular to the travelling direction of the object. There is a specific distance between the laser and the CCD sensor and since the speed of light is not infinitely high, thus restricted to a (nevertheless very high) value of 299792458 m/sec, the laser pulse definitely needs a specific time to travel from the laser source before arriving at the CCD sensor. Since the measurement device, together with the object to which it is mounted rigidly, is moving through Newton's space during the travelling of the laser pulse from the laser source to the CCD sensor it is obvious that the point of arrival of the laser pulse at the sensor is determined by the velocity of the object. This effect is non refutable, since the laser pulse's linear trajectory is completely independent from the source immediately after being emitted by the laser source. The laser pulse does not inherit any velocity component from the object, thus laser source itself, also not in the laser source's and object travelling direction. It is therefore obvious that the measurement device is able to calculate the object's velocity from the point of arrival of the laser pulse at the CCD sensor. The shift of the laser pulse point of arrival at the CCD sensor is called the sensor signal.

Next to the opportunity to measure the absolute velocity in this way, it is also possible to calculate from the derivative of the sensor signal the acceleration of the apparatus and therefore also the acceleration of the material object to which the apparatus is rigidly attached.

Next to the opportunity to measure the absolute velocity and acceleration of the apparatus, thus also the material object to which it is attached to, it is also possible to deploy the absolute velocity measurement apparatus for determining the real position (the perceptible position is different from the real position as explained in the Detailed Description of the Invention) of an object on earth.

The absolute velocity measurement could possibly be implemented in beacons in space which then allow for the determination of a space vehicle's position in space from the code and time information being send by the beacons, moving through space in a fixed formation, and received by the space vehicle.

### BRIEF DESCRIPTION OF THE DRAWINGS

FIG. 1 and FIG. 2 are schematic illustrations of the measurement principle.

FIG. 3 is a schematic illustration of a type A layout of the measurement system. The type A apparatus is based on a container, preferably under vacuum. The type A system incorporates a laser (light) source, a mirror and a photon sensitive sensor. The sensor enables to measure the location of arrival of the pulse (photons), being emitted by the light source and after reflection by the mirror.

FIG. 4 represents an example, illustrating the principle of the measurement by the embodiment of type A.

FIG. 5 illustrates type B of the measuring device. An additional, partially transparent, mirror is incorporated in front of the sensor. In this way multiple reflections can be achieved in principle.

FIG. 6 illustrates type C of the measuring device. No mirror is incorporated while the sensor is located opposite to the photon source.

FIG. 7 is a schematic illustration of a three dimensional based system. There are three axisses (x′, y′ and z′ with each axis perpendicular to the other two). A rigid frame is constructed according to these three axisses. This frame supports three measurement systems of the same build.

FIG. 8 shows the three-dimensional vector analysis of the velocity v in space according to all possible vector components

FIG. 9 shows the two-dimensional vector analysis of a velocity v in space according to the vector components vₓ and v_{y}

FIG. 10 shows the metallic mirror which was used in the technical experiment as a demonstration of the measurement technique

FIG. 11 illustrates the experimental result with respect to the effect of the velocity of the earth in its orbit around the sun, proving the technical feasibility of the measurement technique which is the subject of the present invention

FIG. 12 illustrates schematically (simplified) the four positions of the measurement set-up during cycles of 24 hours and time intervals of six hours as a result of the rotation of the earth

FIG. 13 shows the thought experiment in absolute space which proves that it is possible for both observers to detect in an unambiguous way the simultaneity of two events in positions A and B

FIG. 14, FIG. 15 and FIG. 16 are used in a thought experiment to show in detail the apparent trajectory F1F2 of a laser pulse that is fired from position F1 perfectly perpendicular towards the ceiling but finally arrives at point F2 at the ceiling (instead of arriving in point A) as a result of the displacement of the set-up during the travelling time of the laser pulse. This causes the observer, who moves along with the set-up at the same velocity as the set-up, to observe the apparent (perceptible) trajectory F1F2 of the laser pulse while in reality the laser pulse only travels a distance in absolute space with the same geometrical value as the geometrical distance F1A. This again proves that the common reasoning as being used up to now in the mirror thought experiment in Einstein's train compartment is wrong since in that thought experiment the observer along the train track is wrongly considered to observe an inclined trajectory. As a matter of fact it is the observer in the train compartment who observes the inclined trajectory.

FIG. 17 illustrates the effect of the position of an observer and the position of an observed object which are in rest relative to one another on earth. However, since the earth is moving at a very high velocity through space, the cycling positioning during the earth's rotation with reference to the earth travelling direction has an effect on the perceptible position of the object which also cycles accordingly during the earth's 24 hour rotation cycle. The effect is explained for time intervals of six hours, as indicated in the figure.

FIG. 18 shows the theoretical principle of four beacons which are in a fixed formation in space and allow for a space ship to pinpoint its exact position in space from the individual time codes which are sent by the beacons. The beacons have each an absolute velocity measuring device in order to control their fixed formation.

### DETAILED DESCRIPTION OF THE INVENTION

The measurement principle with respect to the apparatus of the present invention is discussed in detail in the section “Theoretical and experimental aspects of the invention” which comprehends both the theory and experimental demonstration of the principle, including practical consequences and possible applications. The measurement principle of the present invention is straightforward since it is based on irrefutable and basic laws in physics with respect to the behaviour of photons (light; laser pulse).

Regarding the movement of photons in vacuum is has been proven in physics that:
the velocity of photons in vacuum is 299792458 m/sec
the velocity of a photon in vacuum is not influenced by the velocity of the source. The addition of mechanical velocities, as with material objects, is thus not valid in the case of photons. When a material object is launched from a vehicle at a velocity “v” in the direction of the moving vehicle which moves at a speed v_{vehicle} then the velocity of the material object becomes v_{object}=v+v_{vehicle}. When a photon is launched from a light source which has a velocity v_{source} this source velocity is not added to the velocity of the photon since the photon will always move at the same velocity of 299792458 m/sec, whatever the speed of the source.
when photons are launched by a moving light source in a direction perpendicular to the direction of the movement of the light source, the photons also DO NOT acquire the side-way velocity of the light source !
it is thus clear from evidence in physics that a photon or a laser pulse, once launched from the light source, does not inherit ANY velocity vector component of the light source itself
the photons travel in vacuum at a velocity of 299792458 m/sec in a linear trajectory, in the absence of extremely large masses. In practice, it can be stated that a linear trajectory of photons is very obvious for distances on a scale of e.g. 1 m in our galaxy, even in the vicinity of large star or planet masses (e.g. our solar system).

It is also very obvious that the velocity of light is not infinitely high as an information carrier and therefore the transport of information over a specific distance also needs a specific time.

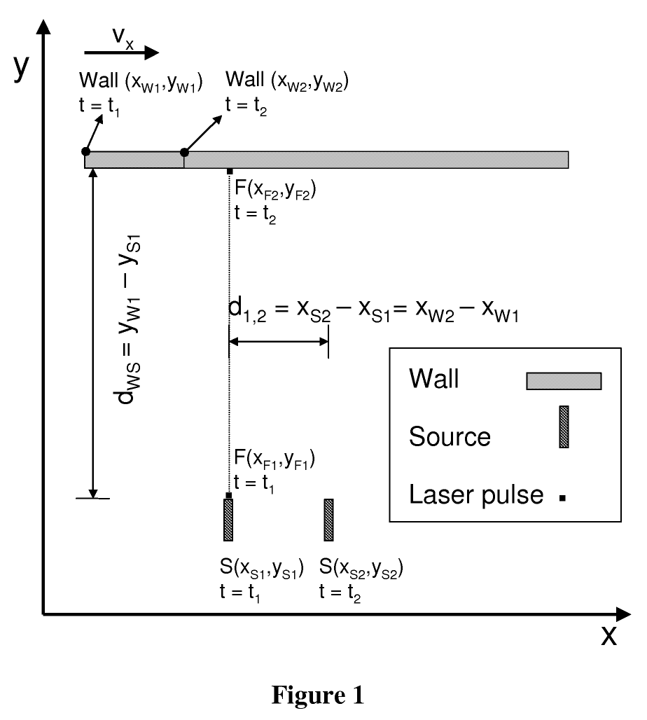

As an example, a light signal needs about one second to be transported from the moon to the earth. The information that an observer on earth receives from the moon is therefore one second old. The light that we observe from the sun even needs about 480 seconds to travel from the sun to the observer on earth. The observed image of the sun is thus already 480 seconds old. When considering FIG. 1 it is thus also clear that when a laser pulse is fired by the laser source in the direction of the opposite wall, the laser pulse will also need a specific time to travel the distance between the source and the wall. This time interval is of course very small but nevertheless not zero. As an arbitrary example, for a distance of 100 meter between the source and wall, the laser pulse needs a travelling time of 1/299792458 sec=3.336 10⁻⁷ sec. This is at first glance an extremely small travelling time which thus appears to be completely neglectable on earth but it can be easily demonstrated on earth that, although very high, the finite velocity of light comprises important effects which can be easily deduced from basic laws of physics but moreover, also easily measured.

When therefore having in FIG. 1: a laser source which has been perfectly aligned on the basis of the geometry of the set-up in a way that the laser source fires a laser pulse according to that perfect geometry in the direction which is perfectly perpendicular to the wall surface. The laser source and the wall are mounted rigidly in one solid structure. Laser source and wall thus can not move relative to one another. When the solid structure of the set-up thus moves only in the x-direction with a velocity vₓ this means that the wall and the laser source also move at the velocity vₓ. A laser pulse which is fired from the laser source thus start to move in the direction perpendicular to the wall and will need 3.336 10⁻⁷ sec to travel to the wall if the distance between the source and the wall is 100 m. As already stated, the laser pulse does not inherit any velocity vector component from the light source and it is thus obvious that the laser pulse does not has a velocity vector component in the x-direction, whatever the value of vₓ. The laser pulse has only a velocity of 299792458 m/sec in the y-direction and does not move at all in the x-direction. This is very important to realize and these statements are completely conform to the classic laws in physics. Since the wall and source do move at a velocity of vₓ this also means that during the travelling time of 3.336 10⁻⁷ sec of the laser pulse from the source to the wall, the source and the wall also travelled in the x-direction according to the simple law in physics which states that the distance being travelled by the wall and source can be calculated by multiplying 3.336 10⁻⁷ sec with vₓ. This leads to the very interesting conclusion that the point of arrival of the laser pulse at the wall is dictated by the velocity vₓ and this finding constitutes the basis for the present invention.

This finding does not infringe any law in physics and even is based on the most obvious and straightforward theories in physics. Therefore this finding is simply irrefutable. Moreover, the theory can be easily demonstrated and proved by experiment.

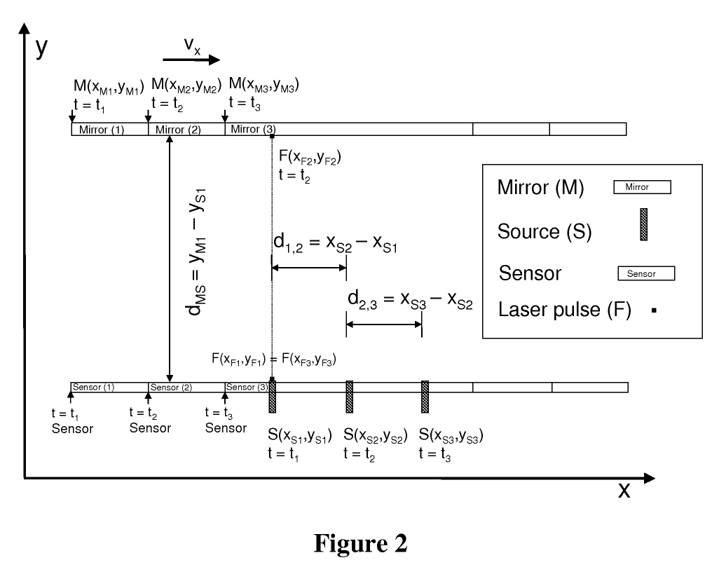

In FIG. 2, a set-up is illustrated which is only a modification of the set-up as presented in the thought experiment in FIG. 1 and which comprises a mirror in order to reflect the laser pulse while doubling the laser pulse's travelling distance. With such a set-up and having a distance between the laser source and the mirror of 100 m the travelling distance would be in total 200 m (towards the mirror and after reflection back to the sensor) and the corresponding travelling time would be 6,672 10⁻⁷ sec. When considering a real experiment on earth with a set-up being based upon FIG. 2 it should be evident to anyone that the set-up is NOT at rest but travels along with our planet through space at a tremendous mean velocity of about 30000 m/sec in the earth's orbit around the sun (while excluding for now the likely separate velocity of our galaxy which should be added then) ! It is thus easy to calculate as a first estimate that:
case 1) when the set-up would be aligned in the same direction as our planet, the set-up velocity “vₓ” would be according to 30000 m/sec (assuming a sophisticated set-up being positioned in the correct direction through e.g. gyroscope control; also not including the likely separate velocity of our galaxy which should be added then)
case 2) when the set-up would be aligned perpendicular to the travelling direction of our planet, the set-up velocity “vₓ” could be approximated (also as a simplification here) to 0 m/sec

there will be a significant distance (30000 m/sec×6,672 10⁻⁷ sec=0.02 m) of 0.02 m between the point of arrival of the laser pulse at the sensor in the first case and the point of arrival of the laser pulse at the sensor in the second case ! It is thus obvious that this principle can be used to measure velocity. Therefore, the principle is the basis for the present invention and further theoretical and experimental details can be found in the section “Theoretical and experimental aspects of the invention” (being further called Annex). In the Annex the effect of the velocity vₓ on the point of arrival of the laser pulse is described in detail in a mathematical way. In the next sections the corresponding mathematical equations and reference coordinate frames, as described in the Annex, are referred to. The concept of absolute velocity and absolute space is also discussed and proven in the Annex.

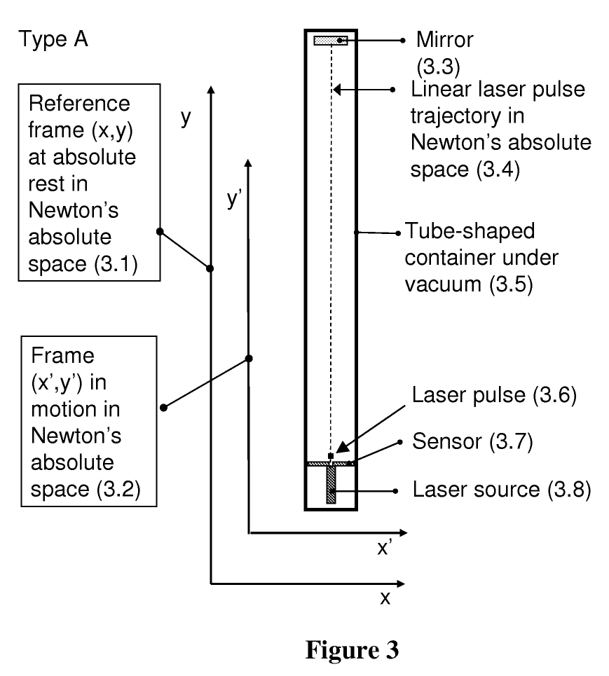

From the discussion with respect to equation (6) in the Annex it is obvious that a moving observer is able to determine the absolute velocity vₓ from the observed laser pulse signal “shift” |x′_{F3}−x′_{F1}| in the observer's coordinate frame (x′, y′). It is therefore possible to construct an embodiment of the present invention as e.g. illustrated in FIGS. 3, 5, 6, and 7. In those figures the axisses x and y represent a coordinate system which is linked to Newton's absolute space and is therefore at absolute rest. In those figures the axisses x′ and y′ represent a coordinate system linked to the observer and the measurement device of the present invention. The frame (x′,y′) thus moves along with the observer and the apparatus through Newton's absolute space while having exactly the same absolute velocity vector components as the observer and the apparatus.

The effects of velocity vector components in the other directions (y and z) are discussed in the Annex. The effect of rotation is also discussed in the Annex.

The apparatus embodiment type A, as illustrated by FIG. 3 comprehends a photon source (3.8). The photon source could be a laser based source. The laser can be pulsed. The photon source (3.8) emits the laser pulse (3.6) through a narrow opening in the photon sensor (3.7) towards the mirror (3.3). The reflecting plane of mirror (3.3) is perfectly perpendicular to the central axis of the tube shaped container (3.5) which preferably is under vacuum. The container (tube) can be of a cylindrical geometry. After emission, the laser pulse moves along a linear trajectory (3.4) in Newton's absolute space towards the mirror (3.3). Upon arrival, the mirror reflects the photon back into the direction of the photon source. Since the apparatus however is also moving in the x-direction through Newton's absolute space, the point of arrival when observed within frame (x′,y′) and detected by the photon sensitive sensor (3.7) is determined by equation (6). The sensor plane is perfectly perpendicular to the central axis of the tube shaped container (central axis is parallel to y′). The sensor (3.7) could e.g. be a CCD, which is also used in digital photo camera's. A charge coupled device (CCD) in a digital photo camera consists of an array of photon sensitive elements. If such an element is hit by photons, a charge (electrons) is created in the element. The array thus captures all photons from the photographed subject where after the charges of the individual array elements can be transferred to a microprocessor or computer which is able to convert the electronic information into an image, corresponding to the photographed subject. It is therefore also possible to use a CCD in the measuring device of the present invention to capture the reflected photons (data-acquisition part) where after the location of the arriving photons on the CCD can be extracted from the CCD image by a microprocessor or a computer. This location then can be converted by mathematical calculations (according to the equation of type (6)) into a vector component of the absolute velocity of the moving coordinate frame (x′,y′), which is the same as the absolute velocity vector component in the x-direction of the moving observer and the moving apparatus itself. The higher the resolution of the CCD (microchips are produced to even a sub-micron scale) and the smaller the laser pulse size, the higher will be the resolution with respect to the measurement of vₓ. The possible deployment of the velocity measuring device in space applications however is clear as a result of the very high velocities in such applications.

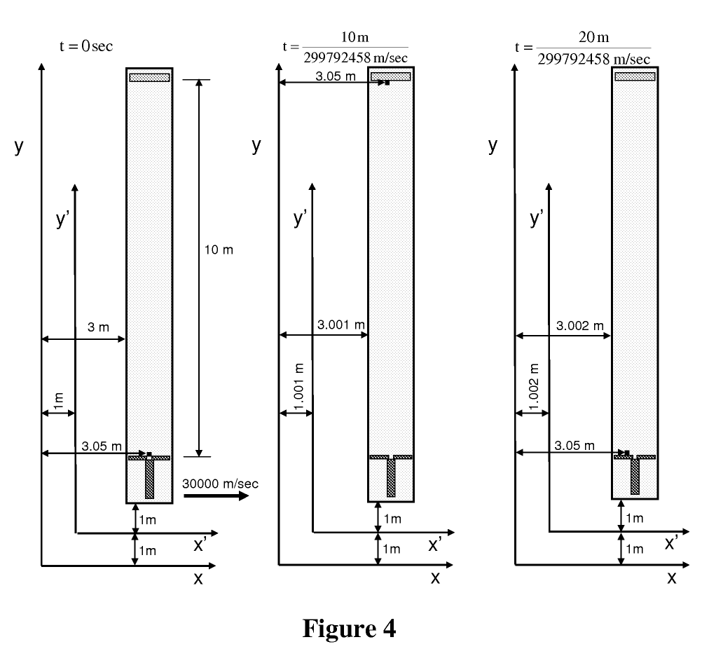

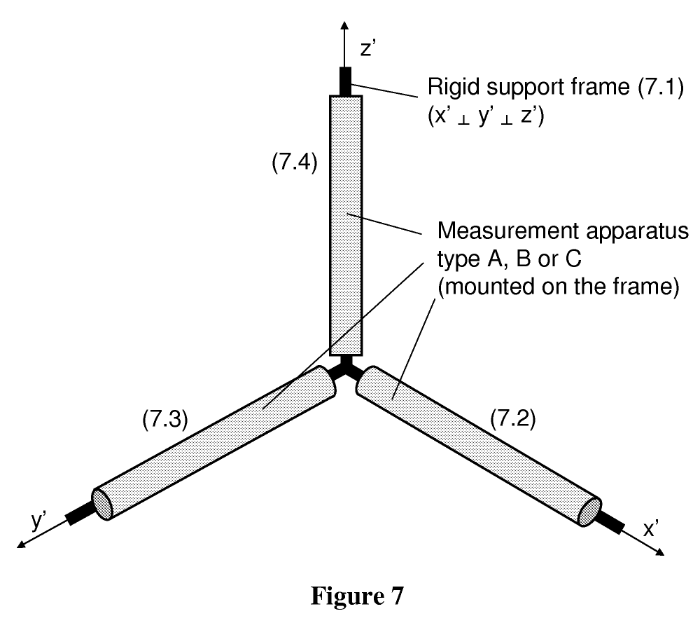

As an example of the use of a type A embodiment of the present invention, a situation is depicted in FIG. 4 where the frame (x′,y′), including the observer and the apparatus of type A, are moving at a velocity vₓ=30000 m/sec (no velocity in y and z direction). It is to be remarked that FIG. 4 is not drawn at correct drawing scales since the purpose of the drawing is only illustrative. The coordinate frame (x,y) is at absolute rest in Newton's absolute space. At t=0, the coordinate system's origin is at the absolute position (x=1,y=1). The lowest and most left coordinate of the container is (x=3, y=2). The distance between photon source and mirror is 10 m. The photon is emitted by the photon (light) source at t=0 sec at the absolute position (x=3.05,y=y_{F}). The photon arrives at the mirror's reflecting surface at t=10/299792458 sec where after the photon arrives at the sensor at t=20/299792458 sec at the absolute position (x=3.05,y=y_{F}) which is exactly the same as the point of emission. However, during the time that the photon travelled to the mirror and to the sensor, the coordinate frame (x′,y′) moved into another absolute position. As a result, the absolute position of the lowest and most left coordinate of the container has changed from the original (x=3, y=2) at t=0 sec into (x=3.002, y=2) at t=20/299792458 sec. The CCD based sensor therefore registers a shift in the value of x′ equal to 0.002 m, between the (x′,y′) coordinate of the photon's departure and the (x′,y′) coordinate of the photon's arrival at the sensor. If an observer within coordinate frame (x′,y′) therefore measures a shift of 0.002 m with the sensor, the observer is able to calculate from equation (6) his/her absolute velocity vector component in the x-direction in Newton's absolute space. Evidently, in this example only one vector velocity component, while being linked to the x-direction, is considered for illustrative reasons but the tackling of a more complex situation incorporating a full three dimensional based velocity vector is explained later when discussing FIG. 7.

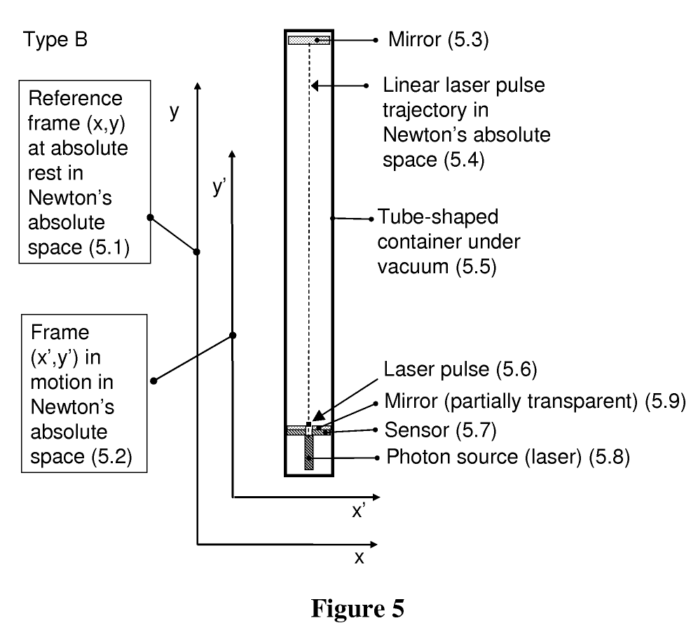

The apparatus embodiment type B, as illustrated by FIG. 5 comprises a photon source (5.8). The photon source could be a laser based source. The laser can be pulsed. The photon source (5.8) emits the photons (5.6) through a narrow opening in the photon sensor (5.7) towards the mirror (5.3). The reflecting plane of mirror (5.3) is perfectly perpendicular to the central axis (central axis is parallel to y′) of the tube shaped container (5.5) which preferably is under vacuum. The container (tube) can be of a cylindrical geometry. After emission, a photon moves along a linear trajectory (5.4) in Newton's absolute space towards the mirror (5.3). Upon arrival, the mirror reflects the photon back into the direction of the photon source. Since the apparatus however is moving through Newton's absolute space, the point of arrival when observed within frame (x′,y′) is determined by equation (6). When having an additional mirror (5.9), the photons from the laser beam therefore can be reflected multiple times by both mirrors (5.3) and (5.9). The sensor below the partially transparent mirror is able to record the multiple signals. The second mirror's and sensor's plane are perfectly perpendicular to the central axis of the tube shaped container (central axis is parallel to y′). The information from the multiple signals can be used in an analogous way as described for type A to calculate the absolute velocity of the moving coordinate frame (x′,y′). The multiple reflections can be looked upon as an “amplification” of the signal, thus increasing the sensitivity of a type B measuring device. To obtain the combination of a CCD based sensor and a transparent second mirror, the second mirror could be produced through a vapour deposition technology, in order to obtain a very thin layer (or layers) on top of the CCD based sensor.

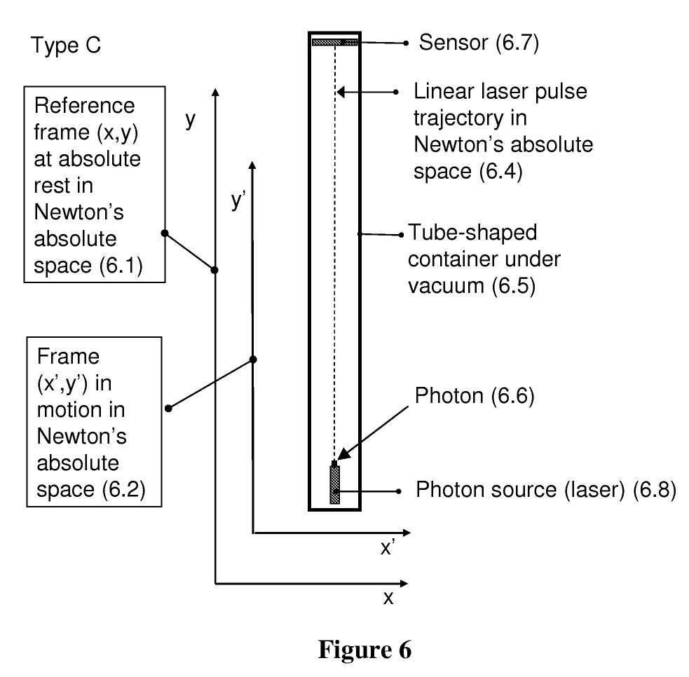

The apparatus embodiment type C, as illustrated by FIG. 6, comprehends a photon source (6.8). The photon source could be a laser based source. The laser can be pulsed. The photon source (6.8) emits the photons (6.6) towards the photon sensitive sensor (6.7). The sensor plane is perfectly perpendicular to the central axis of the tube shaped container (central axis is parallel to y′). The container (tube) is preferentially under vacuum and can be of a cylindrical geometry. After emission, a photon moves along a linear trajectory (6.4) in Newton's absolute space towards the sensor (6.7). Since the apparatus is moving through Newton's absolute space, the point of arrival at the sensor when observed within frame (x′,y′) is determined by the absolute velocity of the coordinate frame (x′,y′). The sensor is able to record the photon's point of arrival. This information can be used in an analogous way as described for type A to calculate the absolute velocity of the moving coordinate frame (x′,y′).

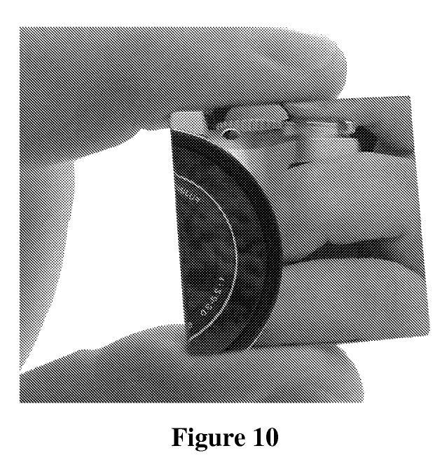

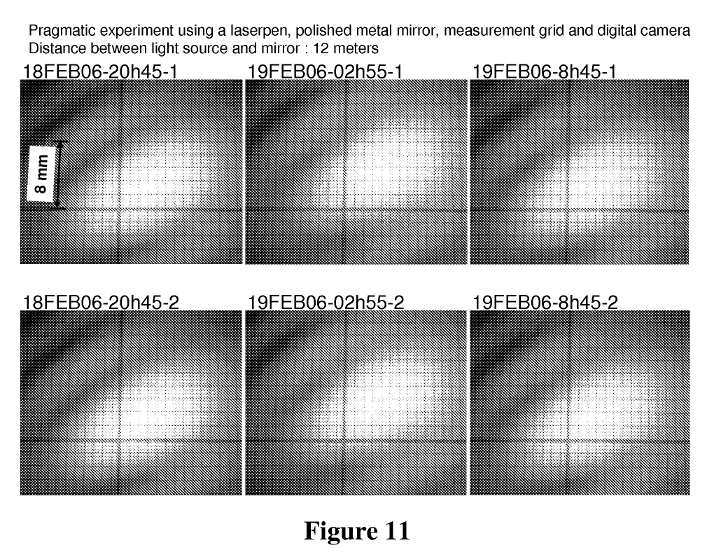

Preliminary experimental evidence of the effect, as predicted by equation (6), was obtained by a set-up which resembles to a type A (FIG. 3) configuration. The experiment is fully explained in the Annex and is therefore considered as an example of the technological feasibility of the measurement technique which is the subject of the present invention. As a photon source, a laser pointer was used. It should be remarked that a practical implementation of the type A, B or C devices would require a laser beam with an optimal and very small beam diameter. Evidently, the laser pointer in this example had no such optimal characteristics but was considered to be sufficient for the proof of the feasibility of the measurement technique. As a mirror, a polished metallic mirror was used in order to avoid the effect of the glass (thickness) of a standard coated glass mirror. The mirror's dimensions were 3 cm×3 cm×0.5 cm and the mirror is shown in FIG. 10. In the experiment, the laser pointer was fixed on a tripod and directed to the metallic mirror, at a distance of about 12 m. The beam was reflected by the mirror towards a wall directly behind the laser pointer. The laser beam spot was captured on a grid, attached to the wall in order to register the laser beam spot's position. The vertical grid unity had a length of about 1.6 mm (24 vertical grid units have a length of about 39 mm). The thick gridlines were drawn manually to produce a visible reference. As illustrated in FIG. 11, macro photographs were taken at a succeeding interval of 6 hours (20 h45 pm, 02 h55 am and 08 h45 am; thus at “darkest” room conditions). In order to show the momentarily stability of the set-up, two photographs were taken within one minute; these are indicated with the indexes “−1” and “−2”. In the photographs the gridlines are inclined, caused by the angle at which the macro photographs had to be taken, out of the path of the reflected laser beam. The digital photo camera was a 3.2 Mega pixel Fujifilm Finepix S304, set at the highest resolution. It was expected to register a maximum relative shift of about 0.002 m (formula (6)) by the effect of the earths rotation, when observed at time intervals of 6 hours. Multiple (qualitative) visual observations indeed confirmed such shifts. From the photographs, a vertical displacement of about 1 vertical grid unit can be observed when comparing the photographs at 20 h45 and 02 h55. Since such a vertical grid unit has a length of about 1.6 mm, the observed displacement is in effect conform to the expected one. The same displacement is observed, but in reverse order, when comparing the photographs at 02 h55 and 08 h45. The photographs thus show the effect, proving the technological feasibility of the measurement technique which is the subject of the present invention.

The combination of three measuring devices (type A, B or C), as depicted in FIG. 7, enables to measure a complete absolute velocity vector of a moving object. By mounting three devices on a rigid frame, having three support beams perpendicular to one another, it is possible to obtain the absolute velocity vector components for each direction (axis) within three dimensions. By applying adequate mathematical formulas, the resulting total and absolute velocity vector can be calculated. It is obvious that such a system then enables to measure the absolute velocity in e.g. a space ship or satellite, without any reference to the outside world. It can be remarked that this contrasts with the concepts of relativity, as already introduced by Galileo.

Next to the measurement of the absolute velocity, it is also possible in principle to evaluate the time derivative of the sensor signal. The time derivative of the sensor signal is related to the momentarily change of the absolute velocity in time, thus the acceleration. As such, the apparatus also enables to measure this momentarily shift with time (dSignal/dt) and calculate from this information the acceleration of the coordinate frame (x′,y′), thus the acceleration of the apparatus and the observer which are linked to (x′,y′). This would be mathematically possible by imposing a regression technique on the signal data, changing with time, in order to obtain a regression curve which fits very well the change of the signal with time. By calculating the tangent from this regression curve at a specific time t, the value of the acceleration at that specific time t can be evaluated.

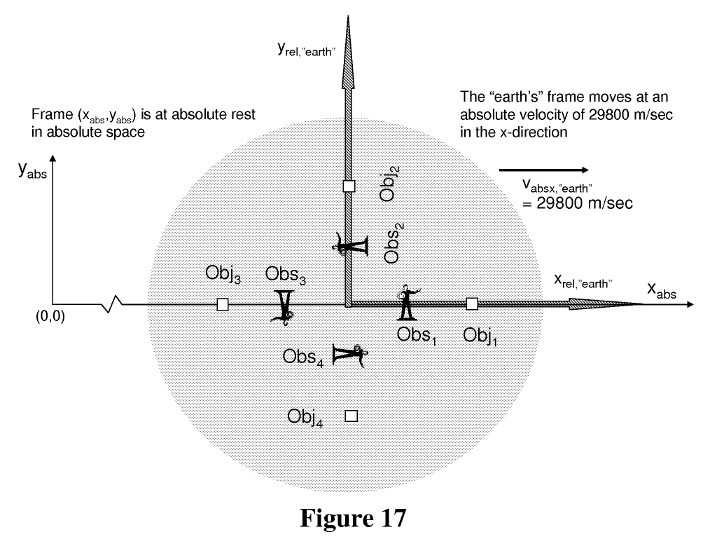

Next to the evaluation of the absolute velocity and acceleration, in principle it is also possible to correct for the perceptible position of an object's real position in space. As an example: since the perceptible position of an object on earth by an observer is based on the information of the incoming light from the object, such image information has travelled a time interval according to the distance between the object and the observer. Since the object on earth moves through space along with the earth at the earth's very high orbit velocity around the sun, this will cause a discrepancy between the perceptible and the real position of the object This is explained in the Annex and by FIG. 17.

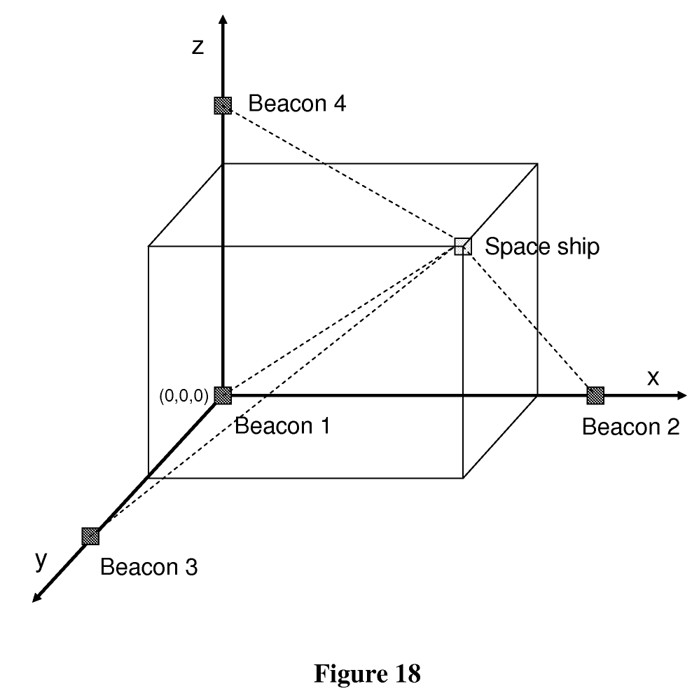

Next to the evaluation of the absolute velocity and acceleration, in principle it is also possible to evaluate the position of a space ship in space. This is explained in the Annex and by FIG. 18.

The present invention, as illustrated by the FIGS. 1-8, is not restricted to the construction as depicted by these schematic drawings. It is obvious that improvements can be obtained by the introduction of e.g. specific (insertable) optical components in the set-up in order to e.g. amplify the signal shift or modify the measuring range.

Theoretical and Experimental Aspects of the Invention (Called Annex)

[Introduction]

Space has always intrigued humans and ultimately, visiting other planets even became a reality. Such space voyages are high tech projects which are only successful through rigid knowledge of fundamental physical and mechanical laws. Such laws were founded by Newton (1642-1727). Newton deduced from the observation of moving and accelerating objects the mechanical laws regarding mass, velocity and acceleration. To define his laws, he needed to introduce the concept of absolute space as an absolute reference in order to be able to define the absolute velocity of a moving material object. Newton tried to prove his concept of absolute space by a non-conclusive experiment and by the extrapolation of his experimental observations towards a thought experiment involving two masses, being connected to one another while revolving in space. Without being able to strictly prove his absolute space concept, Newton however needed to consider both absolute and relative velocity. His laws therefore also imply reference coordinate frames which can also be in motion.

Galileo (1564-1642) already pointed to the principle of relativity. Leibniz (1646-1716) and Mach (1938-1916) also reflected on this principle and continued a philosophical controversy about Newton's absolute space concept. Einstein (1879-1955) increased the controversy by introducing a theoretical concept of the relativity of space and time being based on the fact that the speed of light is constant and a theoretical “thought experiment”. Einstein and Minkowski used the theoretical Lorentz transformation and merged space and time mathematically into a four dimensional Einstein-Minkowski spacetime. Key parameter in Einstein's reasoning to introduce the relativity of space and time is the invariable speed of light in vacuum which induces a paradox resulting from the addition of velocities in inertial reference frames (as presented by Einstein in his well known thought experiment of a train compartment transporting an observer while having a second observer along the train track). The constant speed of light in vacuum is considered as being verified by several experiments, including the original Michelson-Morley experiment. In Einstein's relativity theory each observer's reference frame has a specific clock and length measurement rod, both of which are linked to its speed. Einstein used the Lorentz contraction

$$α = \frac{1}{\sqrt{1 - \frac{{v}^{2}}{{c}^{2}}}} \qquad ( 1 )$$

to calculate the effect of the speed on time and length measurement as being observed. With an increasing speed, the relativity theory claims that the time rate decreases as well as the length of the measurement rod. When nearing the speed of light, the time rate as well as the length of the measurement rod is nearing to zero (the contraction becomes extremely high). From Einstein's perspective, the speed of light therefore would be a physical limit in our universe.

In this Annex, a completely new approach is however presented (see [Theory] and [Experimental] which is founded on very straightforward and basic laws in physics, while also including the constant value of the speed of light. As a result, a laser based measuring device is introduced which in fact enables the measurement of absolute velocity, thus proving Newton's view on absolute velocity. When applying the absolute velocity measuring device within e.g. a space ship, the absolute velocity of the space ship can be measured directly without the need of any reference point from the ship's outside environment. It can be mentioned that Galileo's relativity states that observers in inertial reference frames, which are in uniform motion relative to one another, cannot perform any experiment to determine which one of them is “stationary”. In this Annex the claimed velocity measuring device therefore disproves Galileo's relativity approach. Both observers can each use an absolute velocity measuring device to measure their own absolute velocity status, without the need of any reference point outside their inertial frame. In this way they can also calculate from the two absolute velocities their relative velocity to one another. Consequently, Galileo's “relativity” concept can also be contradicted by experiment. The suggested measurement principle of absolute velocity can thus be easily demonstrated by experiment (see further Experimental) and can have several practical applications in space and on earth, as discussed further.

[Theory]

The speed of light (c) in vacuum is extremely large (299792458 m/sec) but not infinitely high. This “limited” speed has significant effects: e.g. photons travelling from the sun to the earth need about 8 minutes to arrive on earth while a photon's travelling time from e.g. the moon to the earth takes about one second. In fact, as a result of that limited speed of light as an information carrier, the observer obtains delayed information. It is well known that on cosmological scale the light information from objects in space takes millions or billions of years to arrive on earth in a way that the observed objects eventually even ceased to exist already millions of years ago or are in reality in a completely different position in space at the present (and probably have completely different characteristics in the mean time). One thus should keep in mind that the delayed arrival of the light signal's information from a (moving) object in fact corresponds to the object's past position and therefore only informs about a perceptible position of the object and not the real position of the object at that exact moment.

Another effect of the limited light speed is that, when assuming to aim a small laser pulse (also assumed to remain small) from earth towards a specific point at the moon, the moon evidently would have changed position in space during the travelling time (1 second) of the laser pulse. Since the moon has an orbit velocity of about 1000 m/sec, this means that the laser pulse would not hit the moon at the intended point but at a point with a distance of 1000 m remote from the intended point. This is just a non refutable basic event, dictated by basic laws of physics, and the example shows the effect of a target's velocity on the point of arrival of a laser pulse. The discrepancy between the intended point and actual point of arrival as a function of the target's velocity shows moreover a simple linear relation. Obviously, this kind of observation is not only true for large distances but is of course also valid with respect to much smaller distances. For now, it is assumed that Newton's absolute velocity exists (thus also absolute rest) while proof is evident later on in the text. When considering therefore in a thought experiment a reference frame at absolute rest and when simplifying to a two-dimensional case with the axis y and perpendicular to the axis y, as presented in FIG. 1.

While having:
the speed of light (c) in vacuum being equal to 299792458 m/sec
a laser source S which produces a short laser pulse. The laser pulse has also a small diameter. For illustrative reasons the laser pulse is simply represented in FIG. 1 by a dot F. The laser source produces the pulse F at time t=t₁
a wall W at a distance d_{WS} from the laser source
the laser source being rigidly mounted, perfectly aligned in a geometrical way perpendicular towards the wall
the laser source and the wall showing a fixed position to one another. Laser source and wall thus do not move with respect to one another since they are mounted on a rigid common support
F travelling the distance d_{WS} in a linear trajectory (y-direction) towards the position F(x_{F2}, y_{F2}) at the speed of light
F arriving at the wall at time t=t₂
W and S both moving only at an absolute velocity vₓ in de x-direction
the position of W at time t=t₁ being defined by a reference point (x_{W1},y_{W1})
the position of W at time t=t₂ then being defined by (x_{W2},y_{W2}) (notice that on FIG. 1 the wall is drawn twice since it moved from its position at time t₁ to another position at time t₂; therefore on FIG. 1 the second position overlaps the first position in a way only part of the wall's first position is visible in the drawing)
the position of S at time t=t₁ being defined by a reference point (x_{S1},y_{S1})
the position of S at time t=t₂ then being defined by (x_{S2},y_{S2})
the position of F at time t=t₁ being defined by (x_{F1},y_{F1})
the position of F at time t=t₂ then being defined by (x_{F2},y_{F2})
S and W being transported between time t₁ en t₂ through a distance d_{1,2}=x_{S2}−x_{S1}=x_{W2}−x_{W1}

It is first very important to realize that the velocity of light is constant in space (vacuum) and that its speed is not influenced by the laser source's velocity vector components, in whatever direction. As a result, a laser pulse which is “launched” by the laser towards the wall immediately travels at the speed of 299792458 m/sec in the linear trajectory perfectly perpendicular to the wall. It is also trivial that the laser pulse does not inherit the horizontal velocity vector component of the laser source. One can also apply to this setup of a wall and a laser source, the same reasoning with respect to the aforementioned example of the movement of the moon and a laser pulse fired from earth, even for those smaller distances. This is easily made clear by an arbitrary example for the experimental set-up as depicted in FIG. 1:
when having an arbitrary value of d_{WS}=100 m
F will then need 100 m /299792458 m/sec=3.3356 10⁻⁷ sec to arrive at (x_{F2},y_{F2})
when having vₓ=0, the wall and source wouldn't have moved during the travel of F
when e.g. having vₓ=29800 m/s (the mean speed of our planet in it's orbit around the sun; see later the experimental evidence from a real experiment on earth in Experimental), the wall would have moved during the time of travel of F from the source to the wall a distance of 29800 m/sec×3.3356 10⁻⁷ sec=0.0099 m in space
this means that the arrival position of the laser pulse at the wall is a function of the velocity vₓ: in both cases with either vₓ=0 m/sec or either vₓ=29800 m/sec the distance between both observed laser pulse arrival positions would be a noticeable 10 mm ! It is very important to remark that an observer, who has a fixed position with respect to the wall and the laser source, of course would notice this varying position of the pulse arrival position with a varying vₓ.

In this example the photon needs 3.336 10⁻⁷ sec to travel the distance of 100 m. Since the duration of the shortest laser pulses are known to be even smaller than 10 femtoseconds (1 fsec=10⁻¹⁵ sec), the generation of very short laser pulses should be no problem, even for distances of 1 m. To bridge a distance of 1 m the laser pulse needs 3.33 10⁻⁹ sec which is a factor of at least 10⁵ larger than the duration of the shortest laser pulse.

An alternative measurement set-up, involving a mirror, can be introduced as well. When considering a reference frame at absolute rest and when simplifying to a two-dimensional case with the axis y and perpendicular to the axis y, as illustrated in FIG. 2.
a mirror M and laser source S moving in space at a velocity vₓ along the direction of x. The mirror M and laser S do not move with respect to one another. Again, the laser pulse is symbolically represented by a dot F, for illustrative reasons.
the mirror M at a position M(x_{M1}, y_{M1}) at t=t₁
S at a position S(x_{S1}, y_{S1}) at t=t₁; a sensor is also locked to the source. The sensor thus moves along with the source.
F being emitted at position F(x_{F1}, y_{F1}) at time t=t₁ along the direction of y
F travelling the distance d_{MS} in a linear trajectory towards the position F(x_{F2}, y_{F2}) at a velocity c
F travelling this distance F(x_{F1}, y_{F1})_F(x_{F2}, y_{F2}) in a time Δt_{1,2}=t₂−t₁ equal to

$$Δ {t}_{1 , 2} = {t}_{2} - {t}_{1} = \frac{{d}_{MS}}{c} = \frac{{d}_{MS}}{299792458} \qquad ( 2 )$$

M moving from M(x_{M1}, y_{M1}) to M(x_{M2}, y_{M2}) (and S from S(x_{S1}, y_{S1}) to S(x_{S2}, y_{S2})) in the time Δt_{1,2}=t₂−t₁

d_{1,2=}x_{M2}−x_{M1}=vₓ·Δt_{1,2}=x_{S2}−x_{S1} (3)
F arriving at the mirror M (at position M(x_{M2}, y_{M2})) and being reflected at once in a linear trajectory (along the direction of y) towards the position F(x_{F3}, y_{F3}) at t=t₃ which however is identical to F(x_{F1}, y_{F1}) at t=t₁ since F travels back in absolute space in exactly the same linear trajectory and therefore returns to that same original location of emission. So the distance x_{F3}−x_{F1}=0 for any value of vₓ. Note however that when |vₓ|>0 the laser S will have moved from the point of emission and x_{S3}−x_{S1} will be different from zero in that case !
F travelling this distance F(x_{F2}, y_{F2})−F(x_{F3}, y_{F3}) in a time Δt_{2,3}=t₃−t₂ equal to

$$Δ {t}_{2 , 3} = {t}_{3} - {t}_{2} = \frac{{d}_{MS}}{c} = \frac{{d}_{MS}}{299792458} \qquad ( 4 )$$

M moving from M(x_{M2}, y_{M2}) to M(x_{M3}, y_{M3}) (and S from S(x_{S2}, y_{S2}) to S(x_{S3}, y_{S3})) in the time Δt_{2,3}=t₃−t₂

d_{2,3}=x_{M3}−x_{M2}vₓ·Δt_{2,3}x_{S3}−xS2 (5)

Since the velocity of light is constant in space (vacuum) and is not influenced by the source's velocity vector components, in whatever direction, it is obvious that the point of reflection of the laser pulse at the mirror and the point of arrival of the laser pulse at the sensor (after reflection) is again dictated by the absolute velocity vₓ, in the same way as was explained for FIG. 1. This is again easily made clear by an example:
when having an arbitrary value of d_{MS}=10 m
F will then need Δt_{1,2}=10 m/299792458 m/sec=3.3356 10⁻⁸ sec to travel from the source to the mirror
F will then also need Δt_{2,3}=10 m/299792458 m/sec=3.3356 10⁻⁸ sec to travel from the mirror to the sensor
when having an absolute velocity vₓ=0, the source (nor the sensor) nor the mirror wouldn't have moved during the travel of F. In such a case the sensor will register a point of departure of the laser pulse being identical to the point or arrival at the sensor. Thus at the midpoint of the sensor.
when e.g. having vₓ=29800 m/s, the mirror (and source and sensor) would have moved a distance of 29800 m/sec×3.3356 10⁻⁸ sec=0.00099 m in space during the time Δt_{1,2} of travel of F from the source to the mirror. During the time Δt_{2,3} of travel of F after reflection at the mirror to the sensor, the mirror (and source and sensor) would have moved again distance of 0.00099 m in space. As a result, the laser pulse arrives about 2 mm to the left of the sensor's midpoint !

This clearly demonstrates that the position of arrival of the laser pulse at the sensor is a function of the velocity vₓ: in both cases with either vₓ=0 m/sec or either vₓ=29800 m/sec the distance between both laser pulse arrival positions at the sensor would be a noticeable 2 mm. In this Annex, the distance between the laser pulse arrival positions at the sensor as a function of velocity will be defined as “signal shift at the sensor”.

Since the reasoning up to now in this Annex was based on the assumption that Newton's absolute velocity (absolute rest) exists, the proof of that existence and measurability of the absolute velocity of a moving material object in space is now possible. Therefore, a measuring device is introduced here, being derived from FIG. 2 (while being an example an example of one embodiment of the present invention) and schematically illustrated in FIG. 3. A tube-like container under vacuum holds a laser source, a mirror and a sensor. The laser source is geometrically mounted perfectly in a way that the laser points exactly in a perpendicular direction towards the mirror. The mirror is also of premium quality in a way that its plane is perfectly perpendicular to the y-axis. The sensor allows to locate the arriving laser pulse and therefore also the signal shift which is caused by the velocity of the measuring device. The device, in fact then encompasses the ultimate proof of the existence of absolute velocity. Since it is now obvious that the device in FIG. 3 is able to measure the signal shift at the sensor as a function of velocity, one thus should realize that:
if the device travels in the right-handed direction at a specific velocity, the signal shift at the sensor is at the left-handed side of the sensor
if the device travels in the left-handed direction at a specific velocity, the signal shift at the sensor is at the right-handed side of the sensor
therefore it is clear that, when the position of arrival of the reflected laser pulse at the sensor is exactly the same as the point of departure from the source, the only possibility is that the measuring device must be at absolute rest in the x-direction, thus having an absolute velocity equal to zero (simply no velocity to the left nor to the right which can only be equal to absolute rest in the x-direction).

The device in FIG. 3 thus enables the measurement of absolute velocity in one direction.

An alternative point of view with respect to proving the existence of absolute velocity : when firing the laser pulse at the same absolute position xₚ but at different v_{x,absolute} values, the linear trajectory of the laser pulse is always perfectly along the same line x=xₚ being perpendicular to the x-axis at position xₚ. So, in fact it is certainly not some shift of the trajectory of the laser pulse/beam but purely the location shift of the mentioned reflection and arrival points, caused by the displacement of the device itself, travelling through space. When having a reference frame (x′,y′) in which the device is linked to the x′-axis, while showing a zero signal shift at the sensor in the x′-direction, that reference frame can be only at absolute rest in the x′-direction.

When having a three-dimensional set-up, as illustrated schematically in FIG. 7, with three of such tube-shaped devices (according to FIG. 3) perpendicular to one another, a full three-dimensional measurement system is obtained. Such a set-up thus would enable to measure all absolute velocity vector components vₓ, v_{y} and v_{z} (thus also the trajectory direction) in space (see the discussion later on about rotation effects and the possible introduction of gyroscopes to eliminate any set-up rotation). If the signal shifts for all three measuring devices would be zero, the absolute velocity vector components vₓ, v_{y} and v_{z} thus would also be zero and this would indicate that the device is at absolute rest in space in all directions (thus proving the existence of absolute rest and absolute space).

It is very important to notice that an observer, who is travelling along with the device of FIG. 3 (being based on FIG. 2) and thus moves at exactly the same absolute velocity vₓ, of course would also notice a varying signal shift at the sensor when vₓ changes. An observer and the device attached to a frame (x′,y′) moving at the absolute speed vₓ will thus observe the laser pulse to be emitted at a particular position F(x′_{F1}, y′_{F1}) at t=t₁ but will not observe F to return at the same position but at a different position F(x′_{F3}, y′_{F3}) at t=t₃. The distance |x′_{F3}−x′_{F1}| between both points in the reference frame (x′,y′) of observation by the moving observer can be obtained from:

$$\begin{matrix}{x}_{F 3}^{′} - {x}_{F 1}^{′} = {d}_{2 , 3} + {d}_{1 , 2} \\ = {v}_{x} \cdot Δ {t}_{2 , 3} + {v}_{x} \cdot Δ {t}_{1 , 2} \\ = 2 \cdot {v}_{x} \cdot \frac{{d}_{MS}}{299792458}\end{matrix} \qquad ( 6 )$$

It is to be noted that this observation of the signal shift at the sensor can be made by the observer who moves alone with the light source and the mirror. This completely contradicts the “mirror in Einstein's train compartment, while travelling in the x-direction” theory which is often quoted to derive in a mathematical way the Lorentz contraction formula. This is moreover the reason that the view upon which the present invention is based, is claimed to be new. In the “mirror in Einstein's train compartment” thought experiment approach, the observer along the train track (x-direction) is considered to be at rest with respect to the moving train. According to the (wrong) reasoning in the thought experiment, that the observer at rest then would see an inclined path light of the light bundle being reflected by the mirror as a result of the train's movement . . . This is clearly a misconception since an observer at absolute rest would notice the completely opposite: no inclination or shift at all according to FIG. 2 since the photons of the laser pulse move to the mirror and are reflected through absolute space along the very same path ! In reality it is the moving observer in the train compartment who notices a signal shift according to equation (6). In the section [Experimental] of this Annex the effect which can be calculated from equation (6) is even shown to be easily verifiable on earth by experiment while in the section [Implications of the absolute velocity measuring device and practical use thereof] of this Annex the misconception on the “mirror in the train compartment” theory is discussed in more detail.

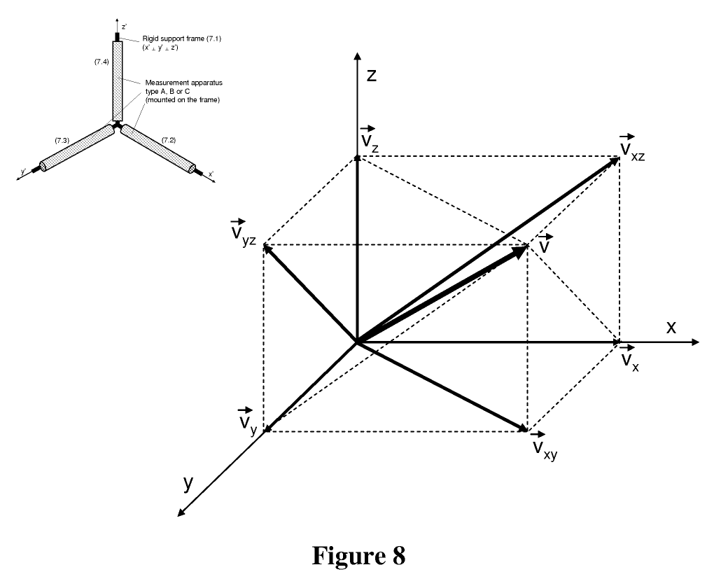

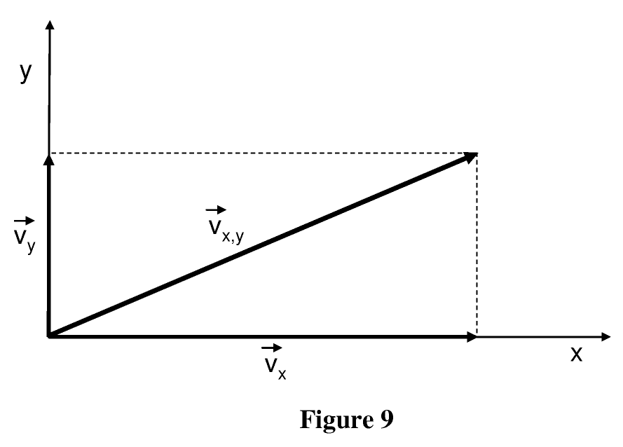

A vector analysis of a velocity vector v in space can be considered, as illustrated in FIG. 8 and FIG. 9. In the three dimensional analysis a velocity v shows three vector components vₓ, v_{y} and v_{z} as shown in FIG. 8. Only the two-dimensional case as shown in FIG. 9 will be discussed here since the reasoning for a three-dimensional case is analogous. Up to now, the discussion was restricted to the one-dimensional case of a velocity vector of which only the vₓ value differs from zero. When having the situation as depicted in FIG. 9 with a velocity vector v_{xy} in the plane (x,y), the velocity measuring device also moves in the y-direction. From the analysis however it is very clear that the measurement of vₓ by the device according to FIG. 3 is not influenced by the perpendicular v_{y} component of the velocity vector: the signal shift from vₓ will remain the same for whatever value of v_{y}. This can be very easily checked by simply drawing the according geometrical linear displacement of the device, resulting from a simple geometrical translation along the direction of the vector v_{xy} in the (x,y) plane (see the discussion in next paragraph about rotation effects and the possible introduction of gyroscopes to eliminate any set-up rotation).

Another aspect should also be mentioned: the effect of a possible rotation of the material object of which the absolute velocity is measured. As a result of the rigid mounting of the velocity measuring to the object, the measuring device is in principle prone to the same rotation. As in normal space applications (space ships, . . . ) such rotation events are restricted to a low number of revolutions and when compared to the high velocities (of which the measurement is the objective of the present invention), it can be easily calculated that the effect of the rotation events on the device signal shift can be neglected. Moreover, a gyroscope based mounting system would allow to have a stable, non-rotating, velocity measuring device without any effect of e.g. a space ship rotation. In the case of a gyroscope based mounting, the type B set-up (FIG. 5), which allows for multiple reflections, can be used in a more efficient way since a larger number of reflections involve a higher total signal shift (signal amplification through multiple reflections) and thus larger measuring range and sensitivity.

[Experimental]

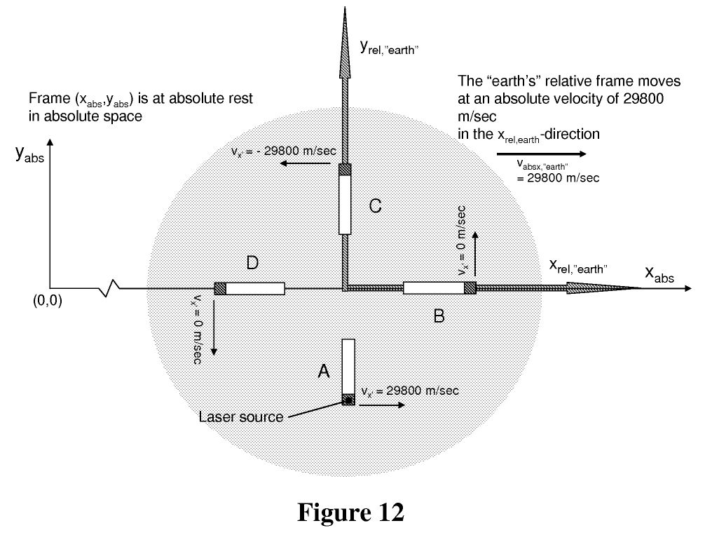

Extra-ordinary experimental conditions exist on our planet and the effect, as expressed by equation (6), can easily be verified on earth, even with simple experimental means. The speed of light is indeed extraordinary high but a varying signal shift is very real on earth since our planet incorporates a tremendous experimental environment. As a result of our planet's very high orbit velocity around the sun (mean value of 29800 m/sec !) and the rotation cycle of 24 hours, it is easy to comprehend that an experimental set-up as depicted schematically in FIG. 12, must show a fluctuating signal shift as the result of a fluctuating vₓ value between minimum and maximum values in a time period of 24 hours. Of course, an exact analysis of the effect of the earth's three dimensional velocity vector components is rather complex since the axis of rotation of the earth is not perpendicular to the earth's orbit plane around the sun and the location of the set-up on earth is also of importance. Moreover, the earth and sun are part of our galaxy which also moves in space. A detailed study would need a team of experts and therefore only a simplified example and approximation is given here, according to the following ideal assumptions (schematically and idealized in FIG. 12):
it is assumed for now that the earth's orbit velocity around the sun is 29800 m/sec and also approximates the absolute value (of course that orbit velocity fluctuates during the time period of a year but the mean value is used here ; moreover the absolute value should be measured by a three-dimensional set-up as e.g. depicted in FIG. 7)
it is also assumed here for idealisation reasons that the orbit trajectory of the earth approximates a linear trajectory very near (although of course in reality the orbit is elliptical)
a maximum value of vₓ=29800 m/sec in the earth's rotational “status A” at the moment that the x′-direction of the device coincides with the earth's orbit travelling direction around the sun
a minimum value vₓ=0 m/sec after 6 hours rotation of the earth called “status B”: the x′-direction of the device is now perpendicular with the earth's orbit travelling direction around the sun
again a maximum value of |vₓ|=29800 m/sec in the earth's rotational “status C” after another time lapse of 6 hours but then in an opposite sense as in case A (vₓ=−29800 m/sec during status C)
again a minimum vₓ=0 m/sec in the earth's rotational “status D” after a time lapse of another 6 hours
the complete cycle all over after another 6 hours

When having d_{MS}=10 m one obtains, according to equation (6), for the earth's status A and status C

x′_{F3}−x′_{F1}=+0.002 m status A:

x′_{F3}−x′_{F1}=−0.002 m status C:

A mirror based set-up thus would show roughly a fluctuation in the position of the reflected laser beam with a maximum of about 4 mm. As indicated before, this value of 4 mm is only indicative since it was already discussed that a detailed analysis would require a three-dimensional calculation, including all parameters (set-up actual location and direction on our planet, actual location of the earth since its orbit speed depends on season status, inclination of earth's rotation axis, etc . . . ).

An indicative experiment was done by simply using a laser pointer as a photon source and by using a mirror (about 3 cm'3 cm×0.5 cm) produced from a polished, flat metallic specimen (FIG. 10). Such mirror was used in order to avoid the effect of the glass (thickness) of a coated glass mirror. In the experiment, the laser pointer was fixed on a camera tripod and the laser beam was directed to the metallic mirror, at a distance of about 12 m. The beam was reflected by the mirror towards a wall directly behind the laser pointer. Evidently a simple laser pointer can not produce a very small spot which was an important disadvantage in the experiment (this would not be the case with sophisticated laboratory laser equipment and experiment). The laser pointer spot was captured on a grid, attached to the wall in order to register its position. The vertical grid unity has a length of 1.6 mm (24 vertical grid units have a length of 39 mm). The thick gridlines were drawn manually to produce a visible reference. In the photographs those gridlines are inclined, caused by the angle at which the macro photographs had to be taken, out of the path of the reflected laser beam. The digital photo camera was set at the highest resolution of 3.2 Mega pixel. It can be remarked that the combination of the grid and digital photo camera in fact represents the concept of a CCD sensor, as discussed earlier. In an effective embodiment of a set-up as depicted in e.g. FIG. 3 the sensor could be a CCD device since such devices are electronic devices and are based on very high resolution pixel arrangements (on a micrometer scale) and thus will allow the detection of very small signal shifts of the incoming laser pulse as a result of changes in the velocity vₓ.

It was expected to register a maximum relative signal shift of roughly 0.002 m (equation (6)) from the effect of the earth's rotation, when observed at time intervals of 6 hours. Multiple visual observations indeed confirmed such shifts. As illustrated in FIG. 11, photographs were then taken at a succeeding interval of 6 hours (20 h45 pm “earth status D”, 02 h55 am “earth status A” and 08 h45 am “earth status B”; thus at “darkest” room conditions). In order to show the momentarily stability of the set-up, two photographs were taken within one minute which are indicated with indexes “−1” and “−2”. From the photographs, the reader can observe a displacement in e.g. the vertical direction of about 1 vertical grid unit when comparing the photographs at 20 h45 and 02 h55. Since such a vertical grid unit has a length of 1.6 mm, the observed displacement is in effect conform to the expected one. One can also observe the same displacement, but in reverse order, when comparing the photographs at 02 h55 and 08 h45. The photographs thus demonstrate the effect but of course a rigorous scientific and fully designed experimental set-up in a laboratory, being based on a detailed analysis including all parameters, would enable a more scientifically and high precision oriented measurement. A precision set-up with only one laser beam could be handled in a scientific laboratory while using a sophisticated laser and (e.g. CCD based) sensor devices to continually track and register the laser beam shifts during a 24 hours period. However an optimal scientific three-dimensional laboratory set-up can be suggested which is based on e.g. FIG. 3 (type A):
one tube of type A is mounted on a (gyroscope) controlled frame which would position the tube perfectly perpendicular to the orbit plane of the earth around the sun. As a result of the earth's rotation, the sensor should register a shift of the reflected laser beam in a 24 hour cycle and a “circular” motion around the sensor's midpoint. Over a complete year, the radius of the 24 hour cycling signal shift circular motion resulting from the earth's rotation would also fluctuate as a result of the changing elliptical orbit velocity of the earth around the sun.
an identical second tube of type A but being rigidly mounted on the same frame but perpendicular to the first tube and controlled (by a gyroscope) to lock the second tube in the direction of e.g. the sun. The second tube would reveal the fluctuating orbit velocity of the earth during its one year elliptical orbit around the sun as a “lateral” signal shift of the reflected laser pulse.
the system could be expanded with a third tube, perpendicular to the other tubes in a way a full three dimensional measurement system as illustrated in FIG. 7 is obtained. Such a three dimensional set-up thus would even enable to measure all earth's velocity vector components vₓ, v_{y} and v_{z} in space.

Variants to improve the set-up with respect to resolution and sensitivity (while e.g. using CCD micro-chip devices with resolutions at the micro-meter (or possibly nano-meter) scale and high precision optics) can be suggested. Whatever sophisticated set-up, such a system eventually could be deployed in space ships or satellites in order to measure and control their absolute speed. Even on planets or moons, such a system would inform about their momentarily absolute velocities in absolute space, including the contribution of the solar system and the galaxy.

[Implications of the Absolute Velocity Measuring Device and Practical Use Thereof]

Relativity Concepts of Galileo, Leibniz, Mach and Einstein

Newton claimed that space is absolute and at absolute rest since the definition of an absolute velocity evidently demanded also an absolute reference coordinate system at absolute rest. According to Newton, space is that ultimate reference system at perfect rest. However, Newton could give no strict proof on this matter while Galileo already had introduced a principle of relativity. According to Galileo, a constant speed can not be evaluated or detected without a direct visible reference towards the environment, which is then considered at “rest”. In his reasoning, a person who is locked inside a completely darkened room in a ship with no means at all of probing (looking) outside that room, is not able to detect the movement or direction of the ship when at a constant speed. According to Galileo, this invokes the relativity principle. Only a relative observation (while needing a contact with the surroundings) is possible according to Galileo but not an absolute one. Mach also introduced a thought experiment in which he imagined all matter (stars, planets, galaxies) to be removed from space with only one observer in space. According to Mach, without any reference points, such an observer would not be able to make any conclusion on speed, direction or position. Also Einstein remarked that a person in a free falling elevator would not be able to distinguish between an uniform motion or an accelerating system from a gravity field (thus distinguish between fictitious inertial forces or real gravity forces).

It is however obvious that when Mach's observer, or an astronaut at the inside of a space ship (within a perfect confinement and even without any reference to the outside world), or the person in the free falling elevator in these thought experiments would use a measurement device as depicted in FIG. 3 and FIG. 7, that person would be perfectly able to measure the absolute velocity and travelling direction. In the falling elevator thought experiment, the person would also be able to notice that the speed is increasing by examining the changing signal shift in the absolute velocity measuring device and thus conclude that she/he is accelerating (within a gravitational field) and thus is not in a status of a uniform motion.

When using the device as e.g. depicted in FIG. 7, it is clear that such device would measure the three absolute velocity components informing an astronaut about absolute speed and also direction. It as also clear that zero sensor signal shifts for the three measurement devices (one for each direction x, y and z) even would indicate that the space ship would be at perfect rest (absolute velocity being zero in each direction). This clearly contradicts Mach's perception in his theoretical thought experiment and also contradicts Galileo's relativity principle.

With respect to Einstein's special relativity theory, the reader should first look herself/himself into Einstein's original thought experiment. Einstein used in his first publication on special relativity a thought experiment (thus purely theoretical) in which he introduces a moving train compartment and an observer Obs1 “at rest” along a train track. In the train compartment there is an additional observer Obs2. Obs1 is positioned in point M which is precisely at the middle of two points A and B along the train track. So the distance AM is the same as the distance MB. The moving train compartment is also exactly in point M at a specific time. Einstein reflected on the effect of two lightning events at the same time in A and B.

According to his reasoning, only observer Obs1 at rest in M would be able to conclude on the simultaneity of both lightning events since the light flash from the lightning in point A would need exactly the same time to travel the distance AM as the light flash from the lightning in point B to travel the distance BM. So Obs1 would be able to conclude that both events happened simultaneously. Einstein reasoned however that Obs2 would not be able to make such a statement since Obs2 is not at rest and is travelling with the speed of the train compartment. When using the principle in physics of adding velocities, Einstein was caught into a contradiction since the speed of light in space was proven to be constant, in whatever frame. He therefore used the Lorentz contraction formula in order to obtain a solution for the situation in which he allowed for a simultaneous contraction of distance (space) and time. As a result of the Lorentz contraction and Einstein's special relativity theory, time stops in a system that is moving at the speed of light while length then also contracts to zero.

Einstein's theory is still not out of debate since a number of paradoxes evolved from his theory which are still questioned today. Those paradoxes heavily solicit human logic. One well known paradox is the twin paradox. The reasoning in the twin paradox leads to the conclusion that it would be possible for humans to travel in the future if the journey in space with a spaceship is done at a very high speed. The twin paradox is the result of Paul Langevin's thought experiment (1911) in which he introduced a pair of twins. One of the twins travels at a very high speed (e.g. 50% of the light speed) into space with a space ship while the other one stays on earth. According to Einstein's relativity the travelling twin member will age less fast than the other member, at “rest” on earth. When the travelling twin member has e.g. travelled a total distance of 5 light years (“forth and back” to earth), he/she will find the other twin member's age to be increased with 10 years. The travelling member, according to the Lorentz transformation (equation (1)), will find himself/herself having aged only 8.86 years since the time for the travelling twin member runs slower in the space ship as a result of the high speed. The higher the space ship's speed, the larger the difference in age between the two twin members (even e.g. 50 years of difference or much higher would be simply possible as a result of the Lorentz contraction). Obviously, according to Einstein's relativity, it would therefore also be possible to travel into the future (in the example the non-travelling twin member and the surroundings at earth the would have progressed already 1.14 year ahead), which is really mind-twisting. With respect to the Langevin paradox itself: this paradox emerges when Langevin used the very relativity principle itself by perfectly stating that, from the relative perspective of the “travelling” twin member in the space ship, the space ship could be considered “at rest” and the earth in motion. In this way, it would be expected that from the same reasoning, the twin member in the space ship would be the one getting older. This paradox being introduced by Langevin of course conflicts heavily with human logic and therefore doubts about the Lorentz contraction of time as a result of a high velocity obviously continue to exist. Some scientists try to get out of this paradox by e.g. stating that the U-shaped (forth and back) travelling trajectory of the twin member in the space ship induces an “asymmetry in relativity” but such reasoning can be simply countered by stating that the travelling trajectory of the space ship can also be assumed to be a perfect circular trajectory in the thought experiment. When having such a circular trajectory with an extremely large radius it is clear that the space ship can keep a constant velocity during its departure and return to the earth: to even remove the effect of the time periods of acceleration and deceleration in the travelling twin thought experiment, it also possible to assume that only a second circular loop is considered which thus shows a constant velocity during the complete trajectory. The space ship then passes the earth at a certain moment and passes again the earth after the envisaged travelling time. In such scenario there is no U-curve what-so-ever, nor acceleration or deceleration in the direction of travelling. Then the paradox of Langevin can not be refuted and relativity thus remains debatable.

Next to the Langevin paradox, the “thought experiment” of Einstein can also be reconsidered while introducing the absolute velocity measuring device in the reasoning. At first, however, the absolute velocity measuring concept is looked into with respect to the characteristics of time as a result of absolute velocity. It can be noted from FIG. 2 and FIG. 3 that the absolute measuring device can also be used as a clock. When having in a thought experiment:
a laser which is pulsed at e.g. a frequency of e.g. precisely one laser pulse per millisecond
a sensor which also counts the laser pulses. In fact this is then an accurate clock which measures time. The observer who moves along with the absolute measuring device can read the clock.

As discussed with respect to the analysis of a velocity vector (e.g. FIG. 9) the validity regarding the clock function for a set-up as presented in FIG. 3 holds when having a v_{y} component which differs from zero. It is evident that the laser pulse travels towards the mirror from the source and needs a somewhat increased travelling time to arrive at the mirror as a result of the value of v_{y}, but this is completely compensated by the somewhat decreased travelling time for the laser pulse to return to the sensor after reflection. Both effects thus completely counterbalance one another and therefore the total travelling distance is not dependent from the value of v_{y}.

It is then obvious that the velocity vₓ has no effect at all on this measurement of time. Whatever value of vₓ, the laser pulse in reality always travels in absolute space exactly the same trajectory (thus distance) and since the speed of light is constant this takes exactly the same time for the laser pulse to travel that constant distance.

When having two space ships at different velocities in space and which are both equipped with an absolute measuring device (being rotation stabilized by gyroscopes) and the clock facility, it is then obvious that time measurement will be identical in both ships. When both clocks would be compared after having travelled in space at different velocities, the clocks would still run perfectly synchronized. It is interesting to note that the absolute velocity measuring device in effect incorporates from this perspective the constancy of the light speed as observed in whatever inertial frame).This reasoning thus questions the time contraction as suggested by Lorentz and answers the Langevin twin paradox which heavily conflicts with human logic: travelling into the future is not possible at all since time is not relative. Langevin's point is thus proven. If a person would argue that in the discussion the laser pulse travels in the y-direction perpendicular to the x-direction, that argument can be easily countered by introducing the three dimensional system of FIG. 7 and three clocks of the same make being based on the set-up of type A (FIG. 3). Since those clocks show an independent time measurement for respectively vₓ, v_{y} and v_{z} they will all keep running perfectly synchronized for whatever value and direction of the velocity vector v.

This time clock aspect of the absolute velocity measuring device also counters the very wrong reasoning with respect to the “mirror experiment in Einstein's train carriage” which is often quoted. As already indicated:
an observer Obs1 at absolute rest in fact will see the real linear laser pulse trajectory in absolute space, thus not a “sideway” trajectory as it is often pictured wrongly (read also further in this text with respect to the importance of the real meaning “at rest” and the important, unnoticed, flaw in Einstein's thought experiment if that observer is not at absolute rest).
it is also in fact the observer Obs2 in the train carriage who notices the signal deviation at the sensor of the absolute measuring device. Therefore Obs2 obviously observes an apparent laser pulse “trajectory” when travelling along with the train carriage. Obs2 thus does not observe the same linear trajectory for whatever speed of the train as often stated very wrongly in literature when describing the light beam trajectory in the “mirror experiment in Einstein's train carriage”. It is non refutable that, the moment that a photon is launched from a light or laser source it will not inherit any velocity component from the light or laser source (thus the train's speed). One could also reflect on the fact that a photon immediately is “launched” with a constant velocity of about 300 000 km/sec from whatever light source at whatever light source's speed which certainly is not related to the principle of the addition of velocities: that principle of the addition of velocities is simply not applicable to a light source and its ejected photons. Photons travel immediately through absolute space (vacuum) at a constant velocity. This could be interpreted also by stating that a photon is dictated by Newton's absolute space as a “medium” to travel at only one possible speed. The photon's speed can not be larger or smaller in vacuum and therefore the photon's degree of freedom in vacuum with respect to it's velocity is zero. This is not the case for a material object: there is definitely a degree of freedom with respect to a material object's absolute velocity in space since that speed can start at a value of zero up towards very high values. The only limit to such speed is imposed by the absolute kinetic energy of the object being defined by equation (7):

E_{k,a}=m.vₐ² (7)

with m=object's mass (kg); vₐ=absolute speed (m/s) and E_{k,a} is the absolute kinetic energy

As the absolute speed increases, the amount of energy which is needed to further increase the velocity increases exponentially. This observation also shows that the mechanical principle of addition of velocities can only by applied to material objects moving in space but is not applicable to photons. When throwing a material object in a moving train, the object's velocity is the sum of the train's velocity and the launching velocity at the moment of throwing the object. The velocity of a light source which emits a laser pulse however has no effect at all in whatever direction on the speed of the laser pulse in space. As a result, the mechanical principle of the addition of velocities obviously can not be applied when describing photons. In that respect, the photon's immediate velocity of about 300000 km/sec in fact emphasizes this, since the light source as a material object does not contribute at all from its own velocity to that phenomenal “launching” velocity of the photon. In fact, the photon's velocity is not linked in any way to the sources “mechanical” velocity but is only dictated by vacuum, since vacuum is the photon's transport medium.

Further remarks can be made with respect to he relativity theory and the practical use of the absolute velocity measuring device in that respect. In Einstein's theoretical thought experiment with a train carriage, an observer Obs1 is “at rest” along the train track. This is a typical “relativity” point of view: the “non moving” train track and the “non moving” observer along the train track are considered to be at rest but the question should be raised if this is absolute rest ? In Einstein's thought experiment and from an “absolute” point of view, the definition of the observer Obs1 to be “at absolute rest” would only be true if the Obs1 would actually read her/his absolute velocity to be zero when reading an absolute velocity measuring device at her/his disposal ! Consequently it is definitely necessary to introduce the absolute velocity measuring device in the thought experiment of Einstein. Consider both observers Obs1 and Obs2 (Obs2 is the observer in the train compartment) to each have an absolute measuring device at their disposal. Consider also a train track on earth and the observer “at rest” along the train track at position M, Obs1 will then measure her/his absolute velocity, including the effect of the earth's velocity. It is to be noted that there is then a flaw in Einstein's reasoning when stating that Obs1 can easily detect the simultaneity of the two lightning flashes. Either Obs1 is considered in Einstein's thought experiment in absolute rest (and then there would be a conflict with relativity altogether since Einstein then would have needed to introduce absolute rest in his thought experiment on relativity itself !) or either Obs1 is in reality moving (as a result of the movement of the earth in space), thus not at rest in such a case. Both options are discussed further.

When considering first a train track on earth it is clear that Obs1 is moving along with the earth and that the very same problem which was imposed by Einstein on Obs2 evidently should also be imposed on Obs1, since both observers are then in fact not at rest. If the human mind is persistent in stating that a train track and an observer along a train track can be considered to be “at rest” it is then obvious that the human mind is imposing on reality an “apparent reality”. Such an approach can have important drawbacks if not handled carefully. As an example: the perceived kinetic energy of an object of 1 kg “at rest” on earth is considered to be zero whereas this is not true. In reality, the object moves along with the earth through space at the tremendous absolute orbit velocity of the earth around the sun. That absolute velocity can be measured with the absolute velocity measuring device. If one assumes for now a velocity of 29800 m/sec as an example, then the kinetic energy of a mass of one kg, being so-called “at rest” on earth, is already an astonishing 44.4 mega Joules in absolute terms. Since there can be only one true absolute physical kinetic energy value in reality, the relative approach of “the mass of one kg at rest” demonstrates that this relative kinetic energy value of zero demonstrates the ability of the human's mind to impose an(y) apparent value on reality. As long as this is only looked upon as a workable “relative” modelling type of data handling, while realizing that this modelling approach implies a high degree of apparency (the kinetic energy of the mass of 1 kg “at rest” appears to be zero but in reality is 44.4 mega Joules; the velocity of the mass of 1 kg appears to be zero but in reality it's absolute velocity is very high) there is no basic problem. However, if this descriptive modelling approach within relative inertial frames is imposed on reality as being THE reality, such approach can no longer be supported. In Einstein's thought experiment the observer Obs1 along the train track on earth is thus not at absolute rest and Obs1 therefore is subject to the very same problem as Obs2 with respect their ability to conclude upon the simultaneity of both lightning events.

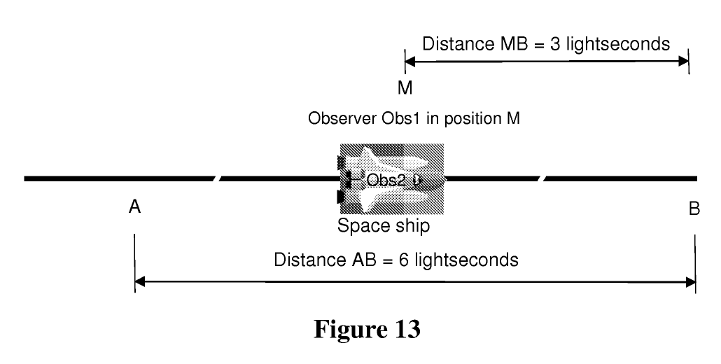

Therefore, let's abandon the situation in Einstein's theoretical thought experiment in the case of a train track on earth and an observer along the track (which evidently is not at absolute rest in reality) and make the abstraction in another thought experiment of having a perfectly linear track AB being at absolute rest in absolute space (controlled by a three axis's based measuring system set-up in positions A and B) according to FIG. 13. Let's assume a space ship which travels along this track in space while an observer Obs2 is on board of the vehicle. Obs2 has an absolute velocity measuring device and is thus able to measure exactly the absolute velocity of the ship. There is also an observer Obs1 along the track in space and Obs1 has also an absolute velocity measuring device which indicates a zero absolute velocity: now Obs1 is really at rest in space. For the simplicity of calculations and ease-of-demonstration reasons, the distance d_{AM} from point A to M (d_{BM} between B and M) is arbitrarily chosen to be 3 light seconds (about 900 000 km) and the velocity of the ship to be 700000 m/sec. In both points A and B there is a laser (also at perfect rest). Both lasers fire at exactly the same moment a laser pulse towards M (LA from A and LB from B). Since Obs1 now is really at absolute rest, both laser pulses will effectively arrive at exactly the same time (after three seconds) at M in a way that Obs1 concludes that they were fired at the same time (Obs1 knows the exact distances AM and BM).

With respect to Obs2 it was shown that time is not influenced by the ship's velocity. The clock of Obs2 therefore runs perfectly synchronized with the clock of Obs1. The observer Obs2 measures the time difference between the arrival of both laser pulses since LB arrives earlier than LA (the ship has moved from position M during the travelling time of both laser pulses).

When:
introducing an absolute x-axis with its origin in M and directed towards B
defining the position of the space ship as X_{Ship}
defining the position of the laser pulse as x_{LB}
Δt_{Ship}=travelling time of the space ship from position M (x=0)
Δt_{LB}=travelling time of the laser pulse from laser LB
Δt_{LA}=travelling time of the laser pulse from laser LA

Since the absolute velocity measuring device is available, the observer Obs2 is able to measure the ship's absolute velocity v_{Ship} and this allows to produce an additional mathematical equation (8) to solve the problem in an exact way. It is very important to comprehend this. The infinite multiplicity of relative inertial frames and relative values for v_{Ship} could be compared with an “underdetermined” (thus unsolvable) mathematical problem but with the ultimate and unique absolute value of v_{Ship}, relativity becomes obsolete and a consistent absolute solution is obtained. The following equations can be written:

x_{Ship}=v_{Ship}·Δt_{Ship} (8)

x_{LB}=d_{MB}−c·Δt_{LB} (9)

x_{LB}=x_{Ship} at the meeting point (10)

When combining these equations to calculate the travelling time at the meeting point this results in:

$$\begin{matrix}Δ {t}_{Meeting , LB \text{-} Ship} = Δ {t}_{LB} \\ = Δ {t}_{Ship} \\ = \frac{{d}_{MB}}{c + {v}_{Ship}} \\ = \frac{3 \cdot c}{c + 700000} \\ = 2.993 sec\end{matrix} \qquad ( 11 )$$

A same procedure can be applied in order to calculate the meeting point of the space ship and the laser pulse LA. This results in equation (12). So, the travelling time at the meeting point of the laser pulse LA and the space ship is:

$$\begin{matrix}Δ {t}_{Meeting , LA \text{-} Ship} = Δ {t}_{LA} \\ = \frac{{d}_{AM}}{c - {v}_{Ship}} \\ = \frac{3 \cdot c}{c - 700000} \\ = 3.007 sec\end{matrix} \qquad ( 12 )$$

Since the observer Obs2 is able to measure the laser pulse's actual arrival times (thus travelling time difference between both laser pulses) and absolute velocity, she/he can easily check from these data and equations, that the pulses must have been fired from the positions A and B at the same time. So, the observer Obs2 is also able to confirm the simultaneous character of the events LA and LB as a result of the knowledge of the ship's absolute velocity. This thought experiment thus illustrates that it is in effect possible to detect the simultaneity of events as a result of the measurement of the absolute velocity by the laser based measurement device. Moreover, in principle, the absolute velocity measuring device allows a real experiment. Therefore, the absolute velocity measuring device, which is the subject of this invention, surpasses relativity theories and proves that Newton's concept of absolute velocity and space is valid.

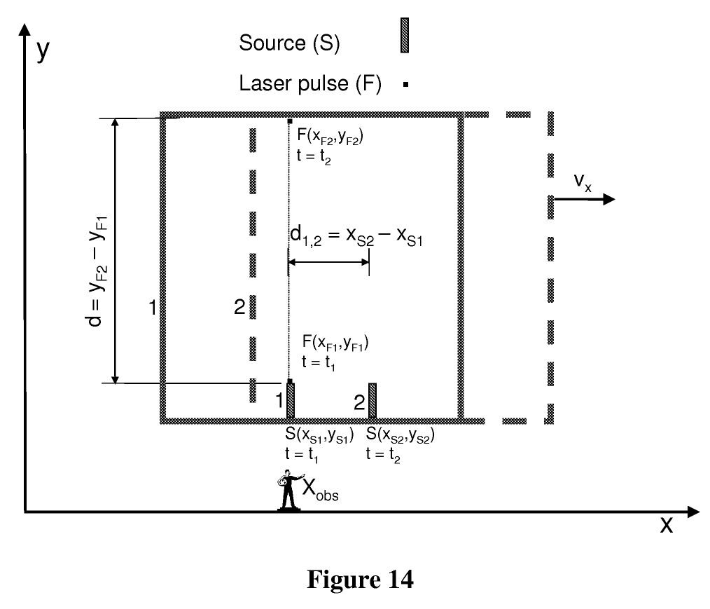

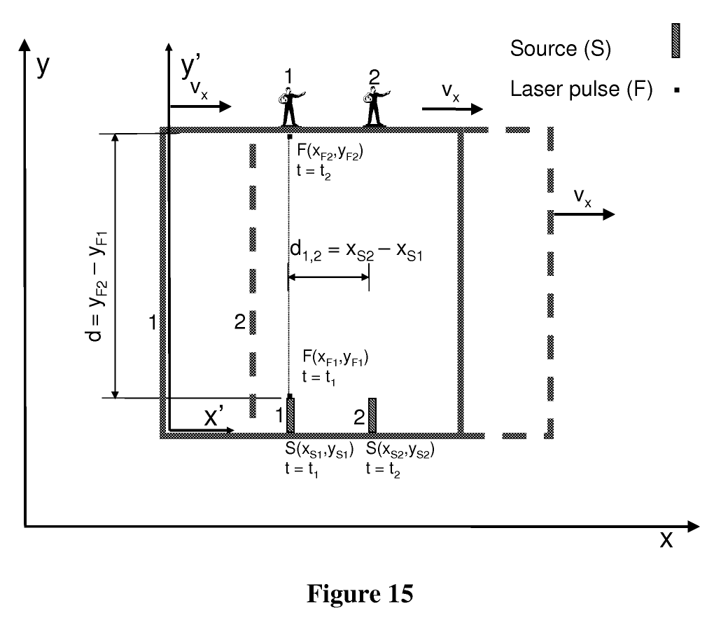

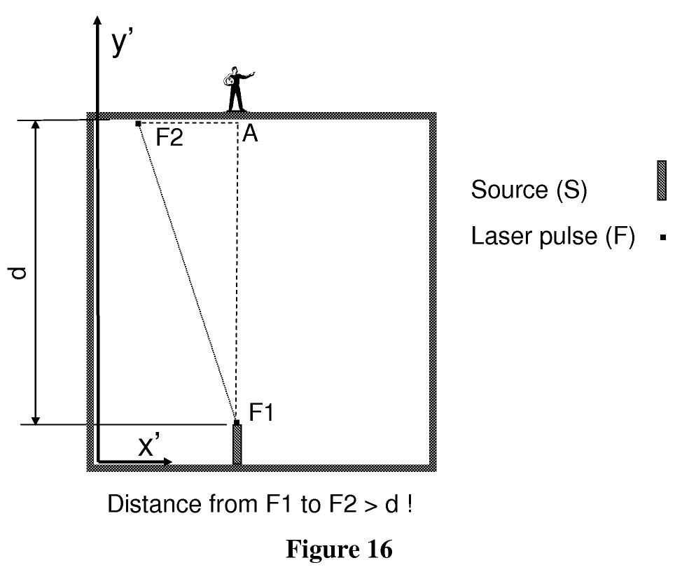

With respect to the constancy of the speed of light in whatever reference frame, the concept of the absolute velocity measuring device can also be used to demonstrate this through a series of thought experiments. An observer is performing four experiments and will measure the speed of light in each experiment. The observer builds an experimental set-up as indicated in FIG. 14:
a rigid structure (rectangular solid frame) holds a laser source S, being rigidly mounted at the bottom of the structure
the laser source S is able to fire a laser pulse perfectly upward in the y-direction of the frame (x,y) (y is perpendicular to x) (the laser construction and placement is made geometrically perfect by specialist scientific equipment builders in that respect)
the plane of the ceiling of the rigid structure is perfectly perpendicular to the y-axis
the observer is first in position x_{OBS} in the frame (x,y) to monitor the travelling of the laser pulse
the absolute speed of the rigid structure (thus also the laser source) is vₓ

Now the observer performs four experiments.

Experiment A is performed while:
vₓ=0; so the structure is at absolute rest in the x-direction
X_{S1}=X_{OBS}
the laser pulse is fired at t=t₁
the observer evaluates the trajectory of the laser pulse from the observer's position X_{OBS}
the laser pulse arrives at the ceiling at t=t₂

It is clear that the laser pulse will travel at the speed of light from the position F(X_{F1},Y_{F1}) along the line y=X_{OBS} towards the position F(X_{F2},Y_{F2}). In fact X_{OBS}=X_{S1}=X_{F1}=X_{F2}. The laser pulse needs a time difference Δt=t₂−ₜ₁ to travel the distance d from F(X_{F1},Y_{F1}) to F(X_{F2},Y_{F2}). The speed of light is obtained by dividing the distance d by the time Δt.

Experiment B is performed while:
vₓ=vₓ, so now the structure actually is travelling in the x-direction
the observer has programmed the system to fire exactly the laser pulse when X_{S1}=X_{OBS}
the observer evaluates the trajectory of the laser pulse, still from her/his position X_{OBS}

Since, according to the laws in physics, the source has no effect at all on the laser pulse with respect to velocity, the laser pulse does not inherit the vₓ component from the laser source and thus travels exactly along the same trajectory as in the first experiment and at the speed of light. So again, the laser pulse travels from the position F(X_{F1},Y_{F1}) along the line y=X_{OBS} towards the position F(X_{F2},Y_{F2}). Again X_{OBS}=X_{S1}=X_{F1}=X_{F2}. The laser pulse needs exactly the same time difference At to travel the distance d from F(X_{F1},Y_{F1}) to F(X_{F2},Y_{F2}). The same value of the speed of light is thus obtained by dividing the distance d by the time Δt.

Experiment C: the observer decide to perform a third experiment under exactly the same conditions but now changes the observation position to position 1 as indicated in FIG. 15, at the top of the structure. The observer wants to know the effect of travelling along with the experimental structure at its travelling speed but, as a reference, starts a third experiment with the structure at rest (vₓ=0). Since this third experiment is performed under exactly the same conditions as the experimental conditions of the first experiment, it is trivial that the observer arrives to exactly the same conclusions and calculation value for the speed of light as in the first and second experiment. Switching observation positions in the first and third experiment of course can have no influence on the phenomena going on and the outcome regarding the speed of light thus must be the same.

Experiment D: the observer decides to repeat the second experiment B in exactly the same way but the only difference is that the observer's position is switched to the position 1 on top of the rigid structure (FIG. 15). So, now the observer travels along with the experimental structure to see the effect. The observer is clearly aware of the fact that the fourth experiment is programmed in exactly the same way as the second experiment and that nothing was changed with respect to the experimental parameters. Therefore experiment 4 is really a reproduction of experiment 2 and only the position of the observer has changed. Of course the observer's mind is perfectly sure that an observer's position can not influence in any way the outcome of an experiment ! And since in physics a completely reproduced experiment always delivers the same result, the observer is really sure that the fourth experiment must reproduce exactly the same result as obtained within the experimental reality within the second experiment. So the observer starts the very same experiment while however looking to the situation as a travelling observer on top of the structure (travelling at a velocity vₓ=vₓ from position 1 to position 2 in FIG. 15). The observer however in reference frame (x′,y′) perceives the situation as depicted in FIG. 16.

Now a paradox evolves since the laser pulse seemingly travelled the perceptible distance F1F2 which is larger than d, while the measured travelling time in both experiments of course is the same. If the observer would accept the value F1F2 as the travelling distance of the laser pulse from his/her observations, the observer is in trouble since then two different results would be the outcome of the same experiment ! The observer however knows the reason of the paradox since if he/she would accept F1F2 as the travelling distance of the laser pulse the observer would accept nonsense conclusions:
the observer knows that the laser pulse was fired in a direction which is perfectly perpendicular to the ceiling. The observer is absolutely sure that the instrument builders mounted the laser source in this respect rigidly to the bottom of the experimental frame, perfectly into a perpendicular direction of the ceiling, but however notices that the perceptible peculiar F1F2 “trajectory” is not conform to the expected perpendicular trajectory F1A. If the observer thus would accept the F1F2 trajectory this would then imply that the observer would accept a nonsense geometrical impossibility ! Therefore the observer recognizes the fact that the movement of the experimental set-up during the laser pulse's travel time causes the “shift” of the expected laser pulse's arrival point (at A) towards the observed position (F2). The observer thus understands that the perceptible F1F2 “trajectory” is an apparent photon trajectory in her/his moving frame and thus needs to be corrected for, into the real and absolute F1A trajectory of the laser pulse in absolute space. This reasoning is really not in conflict with any laws in physics. On the contrary, the laser pulse has simply a finite velocity (fast but finite) but from its (high) absolute velocity the rectangular frame has moved during the travelling time of the laser pulse and therefore the observation of position F2 within a moving reference frame in FIG. 16 is perfectly expected. This is merely basic physics being linked to the simple displacement of a material object as a result of its absolute velocity.
the observer knows also that a photon or laser pulse travels in a perfect linear trajectory through absolute space. In a frame where a photon is travelling in parallel to the y-axis, it is impossible for the photon to have a velocity vector component in the x-axis direction (excluding the very special situation of a gigantic large mass in the immediate vicinity of the photon which bends the photon's trajectory). Claiming an actual horizontal velocity vector component in the x-direction is forbidden in this example, thus also in the (x′,y′) frame of FIG. 16. If the observer would accept the trajectory F1F2 to be the trajectory of the laser pulse, then the observer would infringe the prohibition of a horizontal vector component in this example and thus would impose a non-reality on reality. Of course the observer could use the standard pragmatic approach of modelling the situation within FIG. 16 in a mathematical descriptive way but the observer then should be able to make the abstraction that such description is linked to an apparency, in the same way as the description of the value of the kinetic energy (see equation (17) and further the discussion about that equation).

When having measured the absolute velocity vₓ with the absolute velocity measuring device for the situation, as depicted in FIG. 16, the observer is thus able to implement the correct and straightforward absolute model according to equation (16):

F1F2²=F2A²+F1A²=F2A²+d² (13)

F2A=vₓ·Δt (14)

Thus:

d²=F1F2²−F2A²=F1F2²−(vₓ·Δt)² (15)

d=\sqrt{F1F2²−(vₓ·Δt)²} (16)

The measurement of vₓ and its implementation in equation (16) thus gives the observer the ultimate crucial information (which can be considered as the “missing absolute velocity equation for a material object” in physics) from which the observed position F2 can be corrected for, in a way that the exact absolute travelling distance “d” of the laser pulse in an experimental set-up can be calculated. This thus allows the calculation of the speed of light for whatever value of vₓ, thus for whatever moving frame. In whatever frame, the same velocity value of light thus can be determined, without the need of a Lorentz transformation. The Lorentz transformation in fact could be described as a theoretical, mathematical and artificial transformation from one relative reference frame to another relative reference frame to convert one perception (/apparency) to another perception (/apparency), while disconnecting the absolute reality. This can be compared somehow with the example of the absolute kinetic energy of an object as expressed by equation (7). The absolute reality is the absolute velocity and the absolute kinetic energy of the object while the “perceptible (/apparent) realities” are linked to an infinite number of possible relative reference frames and relative speeds vᵣ. Therefore there can exist in a human's mind also an infinite number of relative (apparent) kinetic energy values E_{k,r} according to equation (17):

E_{k,r}=m.vᵣ² (17)

with

m=object's mass (kg)

vᵣ=relative speed (m/s)

E_{k,r} is the relative (apparent) kinetic energy

As already stated, there can be only one absolute reality outside the human's mind and this is also expressed by equation (16). The Lorentz transformation therefore only describes in a mathematical way an apparent reality, as equation (17) does, while the only possible absolute kinetic energy reality is expressed by equation (7). A major problem thus arises when the Lorentz transformation is claimed as THE (absolute) reality since this is exactly the reason for statements that travelling in the future is possible as a result of the relativity theory and the resulting, until now unresolved, paradoxes such as the Langevin paradox. The absolute velocity measuring device, which is the subject of this invention, allows for the calculation of equation (16) and therefore informs about the single possible absolute reality, while definitely excluding the possibility of travelling in the future as relativity wrongly claims. The Langevin paradox is thus solved as a practical result of the present invention. The present invention also allows, next to the practical applications in space, to be used in practice within scientific experiments.

Misconception with Respect to the Mirror Thought Experiment in Einstein's Train Compartment

In multiple publications the Lorentz contraction formula is derived by using a thought experiment in which a mirror is used in Einstein's train compartment. A mirror is mounted on the floor of the compartment and a light signal is send by a light source from the ceiling towards the mirror at the floor. Instead of using a representation as in FIG. 14 and FIG. 16 regarding the precise observation of a photon's trajectory,
such trajectory as observed by the observer “at rest” outside the train compartment is wrongly drawn in those publications as an inclined trajectory in these publications !
such trajectory as observed by the observer in the train compartment is wrongly drawn in those publications as a trajectory being perpendicular to the floor/ceiling in these publications !

Obviously, this additionally confirms the correct approach as used within the theory, being presented in this Annex, on the absolute velocity measuring device which is the subject of the present invention. This stresses the novelty of the present invention.

[Determining an Object's Real Position from the Perceived Position by Using the Absolute Velocity Measuring Device]

As explained for FIG. 1 and FIG. 2, the finite value of the speed of light results in a small but definite travelling time from the laser source to the wall or the mirror in order. The same is true when an observer on earth observes a stationary object on earth at a given distance. The light signal coming from the object as the information carrier of the object's position also needs a definite travelling time before reaching the observer. The incoming information which the observer receives therefore is delayed according to this travelling time of the light.

This may seem neglectable at a first glance but, as with the flaw in Einstein's thought experiment when he stated that the observer along the train track is at rest and will perceive the two lightning events from point A and B simultaneously, this is certainly not the case. Since any observer travels through space on our planet at a very high velocity (the earth's orbit velocity), the delayed incoming information at the eye of the observer of the light signal from the observed stationary (relative to the observer) object in fact causes a problem with respect to the interpretation of the object's real location. Since from the high absolute velocity of the object (linked to the earth's orbit velocity) the object moves during the travelling time of the light signal and therefore there is an influence of the location of an observer on earth on the real and perceptible position of the stationary object. For now, the absolute velocity of the earth obviously is not known since the sun's planet system is moving itself in space, moreover within our moving galaxy. Moreover, the absolute velocity could be measured with the absolute measurement device but, in addition, the very complicated three dimensional situation of the observer on a revolving earth also needs a profound mathematical analysis. Evidently, an accurate analysis would demand a time demanding project and a team of some specialists. Therefore, in this Annex only an oversimplified representation is pictured in FIG. 17 showing an observer and an object, both stationary on “earth”. The “earth” in this example is restricted to two dimensions, rotating in a 24 h mode in counter clockwise mode. The “earth” has only an absolute velocity in the x-direction in this oversimplified example. Corresponding to time intervals of 6 hours, four succeeding positions of the observer (Obs) and the object (Obj) are drawn. In this example the observer and the object are stationary on earth while the distance between the observer and the object is 10000 m. In position Obs1 and Obj1, the observer and the object move simultaneously in the positive x-direction. A light signal departing from the object in the direction of the observer is not influenced by the velocity of the object and travels through absolute space at its velocity c towards the observer. When assuming an absolute velocity of the earth of 29800 m/sec the observer will thus meet the light signal after a travelling time Δt=3.335×10⁻⁵ sec conform to the equation (18):

29800·Δt=10000−299792458·Δt (18)

Therefore the difference between the real and perceptible position of the object Obj 1 will be about 0.99 m since the object will have moved that distance in the positive x-direction during the travelling time Δt of the light signal. The perceptible position of the object in position Obj1 as evaluated by the observer in position Obs1 at the moment that the delayed light information arrives from the object is thus in absolute terms about 1 m closer to the observer than the real absolute position in absolute space of the, in the meanwhile displaced, object at the moment of the observation. This may seem odd at a first glance but it could be helpful to accept such when reflecting on the fact that e.g. the suns image also arrives only on earth after 480 seconds which means that an observer on earth perceives the sun in a location which happened already 480 seconds in the past and therefore the sun's real position is not observed. From absolute position considerations, a sunset when being defined in a geometrical way as the sun's absolute position disappearing behind the earth's horizon as a result of the rotation of the earth, obviously happened in reality 8 minutes ago while the perceptible image as observed by an observer is linked to observed sunrays corresponding to an 8 minutes old image of the sun's position.

As for positions Obs1/Obj1, the positions Obs3/Obj4 of the observer/object move also simultaneously in the positive x-direction and in this case the observer will meet the light signal after a travelling time Δt=3.336×10⁻⁵ sec conform to the equation (19):

29800·Δt=−10000+299792458·Δt (19)

The difference between the real and perceptible position Obj4 of the object will be about 0.99 m since the object will have moved that distance in the positive x-direction during the travelling time At of the light signal. The apparent position of the object is now about 1 m further from the observer than the real position.

In positions Obs2/Obj2 the observer and the object also move simultaneously in the positive x-direction, but now in parallel. It is to be noticed that this resembles to the situation of the absolute measuring device. Now a light signal departs from the object towards the observer, but in the y-direction. This situation is somewhat more complicated since it could be argued that a hypothetical single photon travelling perfectly in the y-direction could not be perceived by the observer since the observer also moves in the x-direction during the photon's travelling time from the object to the observer. However, in real life, an object being illuminated by e.g. the sunlight during daytime, is reflecting/scattering photons from each object's surface point in all possible directions. Therefore it is clear that the photons which are actually visually captured by the observer are those photons which were send towards the observer at a particular (small) angle, a little off the y-direction. The trajectory could be analysed in detail with the implementation of trigonometric formulas in order to exactly calculate that off-angle (trajectory in absolute space) and the marginally increased travelling distance and travelling time of the light signal towards the observer. For very large distances such exercise could be made but in this case, with the small distance of 10000 m between object and observer, it is assumed that the travelling time can be approximated well by the same value Δt=3.335×10⁻⁵ sec as in the situation of positions Obs1 and Obj1. It can then be concluded that the difference between the object's perceptible and real position is again about 1 m. However, in this case the perceptible position of the object is 1 m further to the observer's left when compared to the real position. For positions Obs4/Obj4 the difference between the object's perceptible and real position is also about 1 m but in that case the perceptible position of the object is then 1 m further to the observer's right when compared to the real one.

The situation in positions Obs2 and Obs4 involves a very small angular shift of 0.006° (which is about 0° 0′ 22″) which is not noticeable to the humans eye. This angular shift is distant independent, in a way that a human's visual perception is unable to detect the differences. However, highly accurate measurement devices would detect the effect and this could be important in a number of very high accuracy positioning applications. This could be done by the assistance of a three dimensional absolute velocity measuring system and by the calculation, through adequate transformation equations, of the real coordinates from the perceptible coordinates of the observed object.

The four examples thus illustrate the difference between perceptible and real positions, even being detectable on earth as a result of the high absolute velocity of the earth in space and the finite velocity as light as an information carrier. In addition, the rotation of our planet causes a cycling situation in the time frame of 24 hours which causes also a cycling difference between real and perceptible position, depending on the position of observer and object. The extrapolation of the oversimplified one-dimensional based examples towards the real three-dimensional situation of the earth of course needs a much more complex analysis in order to set up the correct transformation equations. In addition, the value of the absolute velocity needs to be measured first also. However, the examples show the basis of the approach which is needed and the value of the present invention for that matter.

[The Possible Measurement of the Position of a Space Vehicle in Space by the Assistance the Absolute Velocity Measuring Device]

By the implementation of the absolute velocity measuring device, the position in space of a space ship could be determined in principle by a concept with e.g. four space beacons (Beacon 1 to Beacon 4) as suggested here (FIG. 18). Assume each beacon space vehicle to incorporate:
a three-dimensional absolute velocity measuring device, indicating the space beacon's absolute velocity.
a universally synchronised precise clock
a device which transmits electromagnetic wave signals at a high frequency. Each transmitted signal contains the precise clock value and the beacon's code

When having:
a space vehicle which needs to determine its correct position
also having the universally synchronised precise clock
a receiver in the space ship, being able to continuously receive the transmitted high-frequency signal from all beacons
a device in the space ship which is able to extract the clock value from each single signal at the high frequency and compares it with the clock value inside the space ship. It is then possible to calculate the travelling time of each beacon's signal
the velocity of an electromagnetic wave in absolute space to be equal to the speed c=299792458 m/sec of light (which is also an electromagnetic wave) in space/vacuum it is obvious that within the space ship it is then possible to calculate, from the travelling time of each beacon signal and the speed c, the actual distance between each beacon and the space ship. In the three-dimensional situation it is obvious that, in principle, a stable formation at identical velocity (in the theoretical extreme at absolute rest) of four of such beacon space vehicles in space would allow to pinpoint any space ship's accurate position in space (unambiguously in whatever direction or quadrant position when having four beacons). Beacon1 could be positioned in theory in the origin of a reference frame while the other three (Beacon2, Beacon3 and Beacon4) could be positioned on perpendicular reference axisses x, y and z. This could be done in principle since all beacons have absolute velocity measurement devices on board (including equally gyroscope controlled direction measurements) and are also able to control their mutual distances in order to secure a stable formation in space, as controlled by the comparison of their mutual beacon signals. Those inter-beacon distances which are considered in principle here are of course not on the scale of distances of satellites orbiting around the earth but rather on the distance scale of the earth's orbit around the sun or even larger planet distances.

What I claim as my invention is:

1. An apparatus for determining the absolute velocity vector components of a material object in space, said apparatus being connected to the material object for acquiring the same velocity as the material object; said apparatus consisting of a construction frame comprising one to three support beams; said support beams are being called first support beam and second support beam in the case of two support beams; said support beams are being called first support beam, second support beam and third support beam in the case of three support beams; said second support beam being perpendicular to the first support beam in the case of two support beams; said third support beam being perpendicular to the first and second support beam in the case of three support beams; the direction of said first support beam being linked to a coordinate axis being called x′; the direction of a present second support beam being linked to a coordinate axis being called y′; the direction of a present third support beam being linked to a coordinate axis being called z′; each existing support beam rigidly holding an identical velocity measuring sub-unit being mounted, from a geometrical point of view, perfectly parallel to said corresponding support beam axis; said sub-unit preferably being under vacuum; said sub-unit comprising a light source emitting photons; said light source being preferably a laser source; said laser source being preferably pulsed in order to produce small laser pulses; said photons depart from said light source in a direction which is geometrically perfectly parallel to the direction of the corresponding x′, y′ or z′ axis being linked to said sub-unit; said photons travelling immediately through space in a linear trajectory; said photon's linear trajectory in space being completely independent from any velocity vector component of said light source; said independent movements in space of the photons and said emitting light source being the basis for the detection and calculation of the absolute velocity vector components of the light source and therefore also the detection and calculation of the absolute velocity vector components of said material object.

2. A specific embodiment type A of sub-unit of claim 1 comprising also a, preferably disk shaped, mirror component and a, preferably disk shaped, photon sensitive sensor; said mirror having a perfectly flat surface of which the geometrical plane is perfectly perpendicular to the corresponding direction x′, y′ or z′ being linked to said sub-unit; said mirror is positioned at a specific distance from the light source; said mirror reflecting the photons, preferably the laser pulse, from the light source towards said photon sensitive sensor which is at the level of the light source; said photon sensitive sensor being preferably an electronic CCD (Charge Coupled Device) with a high pixel resolution; said photon sensitive sensor having a perfectly flat surface of which the geometrical plane is perfectly perpendicular to the corresponding direction x′, y′ or z′ being linked to said sub-unit; said photon sensitive sensor detecting the location of arrival of the photons being sent from said light source and reflected by said mirror towards the sensor; the coordinates of said location of arrival of the photons on said photon sensitive sensor being detected and determined; said coordinates of said location being related to the absolute velocity vector components of said light source.

3. A specific embodiment type B of sub-unit of claim 1 comprising also a, preferably disk shaped, first mirror and a combination of a second mirror and a photon sensitive sensor, both preferably disk shaped and both at the level of the light source; said first mirror having a perfectly flat surface of which the geometrical plane is perfectly perpendicular to the corresponding direction x′, y′ or z′ being linked to said sub-unit; said first mirror is positioned at a specific distance from said light source; said first mirror reflecting the photons, preferably the laser pulse, from the light source towards said combination of said second mirror and photon sensitive sensor; said second mirror and photon sensitive sensor having both perfectly flat surfaces of which the geometrical plane is perfectly perpendicular to the corresponding direction x′, y′ or z′ being linked to said sub-unit; said second mirror being semi-transparent; said photon sensitive sensor being positioned directly below the semi-transparent mirror while thus detecting the multiple locations of arrival of the photons being sent from said light source and reflected in a multiple way between said first and second mirror; the coordinates of said locations of arrival being detected and determined; said coordinates of said location being related to the absolute velocity vector components of said light source.

4. A specific embodiment type C of sub-unit of claim 1 comprising also a, preferably disk shaped, photon sensitive sensor; said photon sensitive sensor having a perfectly flat surface of which the geometrical plane is perfectly perpendicular to the corresponding direction x′, y′ or z′ linked to said sub-unit; said photon sensitive sensor is positioned at a specific distance from the light source of said corresponding sub-unit; said photon sensitive sensor detecting the location of arrival of the photons, preferably the laser pulse, being sent from said light source; the coordinates of said location of arrival of the photons on said photon sensitive sensor being detected and determined; said coordinates of said location being related to the absolute velocity vector components of said light source.

5. The apparatus of claim 1 and the embodiments of claims 2, 3, and 4 wherein technical improvements can be made by the addition of specific optical elements (lenses) to enhance the signal shift at the sensor in order to increase the resolution or setting the range of the measurement of the velocity vector components.

6. The apparatus of claim 1 and the embodiments of claims 2, 3, and 4 being used on earth to measure the earth's absolute velocity in order to determine from the perceptible location of an object on earth its precise real position; the said perceptible and said real position of the object not being the same from the combination of the high orbit velocity of the earth around the sun and the finite velocity of light as an information carrier; the difference in perceptible and real position being calculated from adequate mathematical formula's which include the earth's absolute velocity.

7. The apparatus of claim 1 and the embodiments of claims 2, 3, and 4 being used in beacons in space in order to assist in determining a space vehicle's position in space; said beacons being positioned in space in a formation in which each beacon has exactly the same velocity; each beacon velocity being controlled by an individual absolute velocity measuring device; each beacon comprising an identical and synchronised clock; each beacon sending at a high frequency the beacon's code and clock value; each beacon being able to receive the codes and clock values from the other beacons; each beacon being able to calculate from a received code and clock value the position of the sending beacon; each beacon being able to make mutual position corrections in order to secure a stable formation of the beacons; a space ship also comprising an identical and synchronized clock; said space ship receiving the code and clock signals from all beacons in a way that the space ship can evaluate its precise position in space from the difference between the received clock values and the ship's clock value.

8. The apparatus of claim 1 and the embodiments of claims 2, 3, and 4 in order to measure the acceleration of the material object in space from the change in the location of arrival of the photons on the sensor with time; the acceleration being calculated from the time derivative of said location change with time.

9. The apparatus of claim 1 and the embodiments of claims 2, 3, and 4 being mounted on a system being controlled by gyroscopes in order to prevent any rotation of said apparatus, while increasing the sensitivity and range of the velocity measurement.

10. The embodiment of claim 3 of which the combination of a second mirror and photon sensitive sensor is obtained by applying the second mirror on the sensor's surface through a thin film technology such as e.g. vapour deposition; said thin film mirror not interfering with the sensor's electronic function, possibly by using an intermediate isolating thin film.
